(19) United States
(12) Patent Application Publication
(10) Pub. No.: US 2017/0121565 A1
(43) Pub. Date: May 4, 2017

(54) TRANSPARENT RESIN LAYER, PRESSURE-SENSITIVE-ADHESIVE-LAYER-ATTACHED POLARIZING FILM, AND IMAGE DISPLAY DEVICE

(71) Applicant: NITTO DENKO CORPORATION, Ibaraki-shi, Osaka (JP)

(72) Inventors: Atsushi Yasui, Ibaraki-shi (JP); Hirofumi Katami, Ibaraki-shi (JP); Masaki Mizutani, Ibaraki-shi (JP)

(73) Assignee: NITTO DENKO CORPORATION, Ibaraki-shi, Osaka (JP)

(21) Appl. No.: 15/301,874

(22) PCT Filed: Mar. 27, 2015
(86) PCT No.: PCT/JP2015/059706

§ 371 Date: Oct. 4, 2016

(30) Foreign Application Priority Data
Apr. 4, 2014 (JP) 2014-077808

(51) Int. Cl. C09J 7/02; B32B 7/12; B32B 27/06; G09F 9/35; G02F 1/1333; G02F 1/1335; G02B 1/16; G06F 3/044; C09J 133/06; G02B 5/30

(52) U.S. Cl. CPC C09J 7/0217; C09J 133/066; B32B 7/12; B32B 27/06; G02B 5/3041; G02F 1/13338; G02F 1/133528; G02B 1/16; G06F 3/044; G09F 9/35; B32B 2307/42; B32B 2307/412; G02F 2202/22

(57) ABSTRACT

A transparent resin layer (A) having a surface resistance of 1.0×10¹³Ω/□ or less is placed more on the viewer side than the most viewer side polarizing film (1) in an image display device (B). The transparent resin layer (A) can be made from a transparent pressure-sensitive adhesive or a transparent liquid resin. Without degrading the reliability of the most viewer side polarizing film (1), the transparent resin layer (A) can impart an antistatic function at such a level as not to reduce the sensitivity of a touch panel.

### TECHNICAL FIELD

The invention relates to a transparent resin layer that is placed more on the viewer side than the most viewer side polarizing film in an image display device. The invention also relates to a pressure-sensitive-adhesive-layer-attached polarizing film including a polarizing film and the transparent resin layer provided as a transparent pressure-sensitive adhesive layer on the polarizing film. The invention also relates to an image display device in which the transparent resin layer (or the transparent pressure-sensitive adhesive layer of the pressure-sensitive-adhesive-layer-attached polarizing film) is provided more on the viewer side than the most viewer side polarizing film. The image display device may be, for example, a liquid crystal display device, an organic electroluminescence (EL) display device, a plasma display panel (PDP), or an electronic paper.

The transparent resin layer of the invention can be made from, for example, a transparent pressure-sensitive adhesive or a transparent liquid resin. The transparent resin layer of the invention is preferably applied, for example, between a polarizing film and a viewer-side component of an image display device, such as an input device such as a touch panel, a cover glass, a plastic cover, or any other transparent substrate. The transparent resin layer of the invention is preferably for use on a touch panel such as an optical, ultrasonic, capacitive, or resistive touch panel. In particular, the transparent resin layer of the invention is preferably for use on a capacitive touch panel. Examples of uses of the touch panel include, but are not limited to, cellular phones, tablet computers, and personal digital assistances.

### BACKGROUND ART

In recent years, input devices having a combination of a touch panel and an image display device, such as a liquid crystal display device such as cellular phones and portable music players, have become popular. In particular, capacitive touch panels have rapidly become popular because of their functionality.

There are now many known transparent conductive films for use in touch panels, which include a laminate of a transparent plastic film substrate or a glass sheet and a transparent conductive thin coating (ITO coating). A transparent conductive film can be placed on any other member with a pressure-sensitive adhesive layer interposed therebetween. Various types of pressure-sensitive adhesive layers are proposed (see Patent Documents 1 to 5).

When the transparent conductive film is used as an electrode substrate for a capacitive touch panel, the transparent conductive thin coating used is patterned. The transparent conductive film with the patterned transparent conductive thin coating is placed on another transparent conductive film or any other component with a pressure-sensitive adhesive layer interposed therebetween to form a laminate to be used. These transparent conductive films are advantageously used for a multi-touch input device, which can be operated by touching it with two or more fingers at the same time. Specifically, a capacitive touch panel is designed to achieve sensing when the amount of change in output signal, which is generated at a position where the touch panel is touched with a finger or the like, exceeds a certain threshold value.

### PRIOR ART DOCUMENTS

### Patent Documents

Patent Document 1: JP-A-2003-238915

Patent Document 2: JP-A-2003-342542

Patent Document 3: JP-A-2004-231723

Patent Document 4: JP-A-2002-363530

Patent Document 5: JP-A-2012-246477

### SUMMARY OF THE INVENTION

### Problems to be Solved by the Invention

Static electricity can be generated during the manufacture of image display devices and other processes. In such a case, for example, in a liquid crystal display device, the static electricity can affect the orientation of the inner liquid crystal to cause a failure. In addition, the static electricity may also cause display unevenness when the liquid crystal display device operates. In order to prevent the occurrence of static electricity in a liquid crystal display device, for example, an antistatic function can be imparted to a pressure-sensitive adhesive layer provided between the liquid crystal cell and a polarizing film on the viewer side, or an antistatic layer can be provided between them. Unfortunately, when a surfactant or an ionic compound for imparting an antistatic function is added to the pressure-sensitive adhesive layer, the polarizing film may have reduced reliability in a heating test or a heating and humidifying test.

In some image display devices, a touch panel is placed more on the viewer side than the viewer-side polarizing film. In order to prevent the occurrence of static electricity, such a touch panel needs to have an antistatic function at such a level as not to reduce its sensitivity. For example, if an image display device (liquid crystal display device) has an antistatic layer (such as an ITO layer) on the viewer-side surface of the liquid crystal panel, the static electricity-induced unevenness can be suppressed to a certain extent. Unfortunately, depending on the type of the antistatic agent added, such an antistatic layer provided on the viewer-side surface of the liquid crystal panel is more likely to cause a problem such as depolarization, impurity-induced occurrence of bright spots, or any other type of degradation of optical properties, which means that the polarizing film on the viewer side is not considered to have sufficient reliability. In a liquid crystal display device with a built-in in-cell touch sensor, the viewer-side surface of the liquid crystal panel is not provided with any antistatic layer for preventing static electricity-induced unevenness. In a liquid crystal display device with a built-in on-cell touch sensor, an antistatic layer is formed on the viewer-side surface of the liquid crystal panel, but the antistatic layer is patterned for grounding and thus missing in some parts. Therefore, these liquid crystal display devices with a built-in touch sensor are not considered to have a sufficient antistatic function.

It is therefore an object of the invention to provide a transparent resin layer that does not degrade the reliability of the most viewer side polarizing film in an image display device and can impart an antistatic function at a such level as not to reduce the sensitivity of a touch panel.

It is another object of the invention to provide a pressure-sensitive-adhesive-layer-attached polarizing film including a polarizing film and such a transparent resin layer provided as a transparent pressure-sensitive adhesive layer on the polarizing film. It is a further object of the invention to provide an image display device having such a transparent resin layer or such a pressure-sensitive-adhesive-layer-attached polarizing film.

### Means for Solving the Problems

As a result of intensive studies to solve the problems, the inventors have accomplished the invention by finding the transparent resin layer described below.

The invention relates to a transparent resin layer to be placed more on a viewer side than a most viewer side polarizing film in an image display device, the transparent resin layer having a surface resistance of 1.0×10¹³Ω/□ or less.

The transparent resin layer preferably has a thickness of 5 μm to 1 mm. Also, the transparent resin layer preferably has a value of 1.0×10¹² Ω·cm or less calculated by multiplying the surface resistance (Ω/□) by a thickness (cm) of the transparent resin layer.

The formation material of the transparent resin layer preferably comprises an acryl-based polymer as a base polymer.

The formation material of the transparent resin layer preferably comprises an ionic compound.

The formation material of the transparent resin layer is preferably a transparent pressure-sensitive adhesive. Also, The formation material of the transparent resin layer is preferably made from a transparent liquid resin.

The transparent resin layer is preferably for use on a touch panel. Especially, the transparent resin layer is preferably for use in a liquid crystal display device having a built-in in-cell or on-cell touch sensor.

The invention relates to a pressure-sensitive-adhesive-layer-attached polarizing film, comprising:
a most viewer side polarizing film in an image display device; and
a pressure-sensitive adhesive layer to be placed more on a viewer side than the polarizing film, wherein
the pressure-sensitive adhesive layer is the transparent resin layer made from a transparent pressure-sensitive adhesive.

The invention is also directed to an image display device including: at least one polarizing film; and at least one transparent resin layer provided more on the viewer side than the most viewer side polarizing film in the image display device. In the image display device, the transparent resin layer may be provided as the pressure-sensitive adhesive layer of the pressure-sensitive-adhesive-layer-attached polarizing film.

### Effect of the Invention

The transparent resin layer of the invention has a surface resistance of 1.0×10¹³ Ψ/□ or less and thus an antistatic function. In addition, the transparent resin layer is placed more on the viewer side than the most viewer side polarizing film in an image display device (e.g., a liquid crystal display device) having a tough panel. Therefore, the transparent resin layer can significantly reduce a problem such as depolarization, impurity-induced occurrence of bright spots, or any other type of degradation of optical properties, which would otherwise occur when an antistatic layer (low surface resistance layer) is provided between the viewer-side polarizing film and the liquid crystal panel, and does not degrade the reliability of the most viewer side polarizing film. Thus, the transparent resin layer of the invention can impart a suitable level of antistatic function to a touch panel without degrading the performance of an image display device.

In particular, the transparent resin layer of the invention is effectively used in a liquid crystal display device with a built-in in-cell or on-cell touch sensor. For example, the transparent resin layer of the invention may be provided as a pressure-sensitive adhesive layer on the most viewer side polarizing film. In this case, a high-quality liquid crystal display device with a built-in in-cell or on-cell touch sensor can be provided.

When the transparent resin layer is used as a pressure-sensitive adhesive layer, a pressure-sensitive-adhesive-layer-attached polarizing film may be prepared in advance, which has high durability when used in an image display device. The pressure-sensitive-adhesive-layer-attached polarizing film is preferred for the reliability of the most viewer side polarizing film.

### BRIEF DESCRIPTION OF THE DRAWINGS

FIG. 1 is a schematic diagram showing where to place the transparent resin layer of the invention on an image display device.

FIG. 2 is a schematic diagram schematically showing how an image display device and a component are bonded with the transparent resin layer of the invention interposed therebetween.

FIG. 3a is a cross-sectional view schematically showing an embodiment of the image display device.

FIG. 3b is a cross-sectional view schematically showing an embodiment of the image display device.

FIG. 3c is a cross-sectional view schematically showing an embodiment of the image display device.

FIG. 4a is a cross-sectional view schematically showing an embodiment of the touch panel.

FIG. 4b is a cross-sectional view schematically showing an embodiment of the touch panel.

### MODE FOR CARRYING OUT THE INVENTION

Hereinafter, embodiments of the transparent resin layer of the invention will be described in detail with reference to the drawings. It will be understood that the embodiments shown in the drawings are not intended to limit the invention.

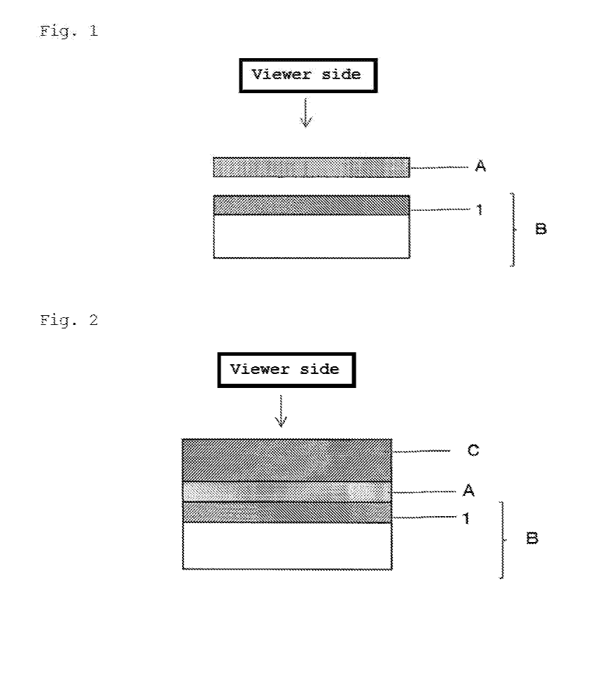

Referring to FIG. 1, in an image display device B having at least one polarizing film 1, a transparent resin layer A according to the invention is placed more on the viewer side than the most viewer side polarizing film 1.

FIG. 2 is a schematic diagram schematically showing a case where a member C is bonded to the most viewer side polarizing film 1 with a transparent resin layer A interposed therebetween in an image display device B. In FIG. 2, the transparent resin layer A may be used as a transparent pressure-sensitive adhesive layer or a transparent liquid resin layer. When the transparent resin layer A is a transparent pressure-sensitive adhesive layer, the transparent resin layer A may be previously provided on the polarizing film 1 so that the polarizing film 1 can be used in the form of a pressure-sensitive-adhesive-layer-attached polarizing film. The member C may be, for example, an input device such as a touch panel, a cover glass, a plastic cover, or any other transparent substrate for use on the viewer side of the image display device.

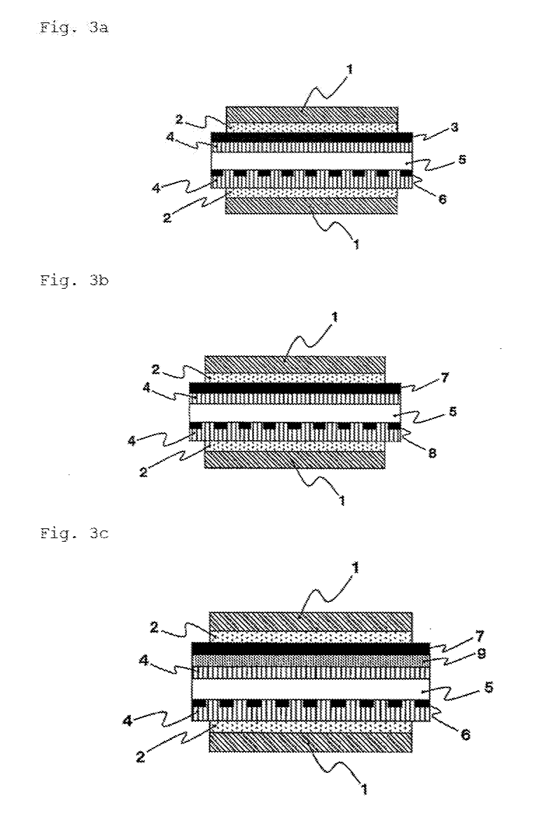

The image display device B has at least one polarizing film 1. The image display device B may be, for example, a liquid crystal display device, an organic electroluminescence (EL) display device, a plasma display panel (PDP), or an electronic paper. The image display device B is preferably a liquid crystal display device including a liquid crystal layer 5 and polarizing films 1 provided on both sides of the liquid crystal layer 5. FIGS. 3a, 3b, and 3c are cross-sectional views schematically showing typical examples of the image display device (liquid crystal display device). In the image display devices (liquid crystal display devices) of FIGS. 3a to 3c, the upper polarizing film 1 is located on the most viewer side.

The image display device (liquid crystal display device) illustrated in FIG. 3a has a structure of “polarizing film 1 (at the viewer-side)/pressure-sensitive adhesive layer 2/antistatic layer 3/glass substrate 4/liquid crystal layer 5/driving electrode 6/glass substrate 4/pressure-sensitive adhesive layer 2/polarizing film 1”. The antistatic layer 3 and the driving electrode 6 may be made of a transparent conductive layer. The antistatic layer 3 is optionally formed.

The image display device (liquid crystal display device) illustrated in FIG. 3b is a device in which a transparent conductive layer is used as an electrode of a touch panel (in-cell type touch panel). The device has a structure of “polarizing film 1 (at the viewer-side)/pressure-sensitive adhesive layer 2/antistatic layer 7 functioning also as a sensor layer/glass substrate 4/liquid crystal layer 5/driving electrode 8 functioning also as a sensor layer/glass substrate 4/pressure-sensitive adhesive layer 2/polarizing film 1”. The antistatic layer 7, the driving electrode 8 and the driving electrode 6 may each be made of a transparent conductive layer.

The image display device (liquid crystal display device) illustrated in FIG. 3c is a device in which a transparent conductive layer is used as an electrode of a touch panel (on-cell type touch panel). The device has a structure of “polarizing film 1/pressure-sensitive adhesive layer 2/antistatic layer 7 functioning also as a sensor layer/sensor layer 9/glass substrate 4/liquid crystal layer 5/driving electrode 6/glass substrate 4/pressure-sensitive adhesive layer 2/polarizing film 1”. The antistatic layer 7, the sensor layer 9 and the driving electrode 6 may each be made of a transparent conductive layer.

A polarizing film including a polarizer and a transparent protective film provided on one or both sides of the polarizer is generally used. A functional layer such as a hard coat layer may be laid onto the transparent protective film in the polarizing film. Additionally, an optical film is appropriately used which is usable to form a liquid crystal display device, an organic EL display device or some other image display device. The optical film may be used as other optical layers, such as a reflective plate, a transflective plate, a retardation plate (a half wavelength plate and a quarter wavelength plate included), an optical compensation film, a viewing angle compensation film and a brightness enhancement film, which may be used for formation of a liquid crystal display device etc. These films may be singly used as the optical film, or one or more thereof may be used in the state of being laminated onto the polarizing film when practically used.

A pressure-sensitive adhesive layer (corresponding to, for example, the pressure-sensitive adhesive 2 in FIGS. 3a to 3c) may be formed on the polarizing or optical film so that the polarizing or optical film can be bonded to any other member such as a liquid crystal cell (glass substrate). For the pressure-sensitive adhesive layer, a pressure-sensitive adhesive that may be of various types is appropriately selected to be used, this adhesive containing, as a base polymer, for example, an acryl-based polymer, silicone polymer, polyester, polyurethane, polyamide, polyether, fluoropolymer, or rubber-based polymer. Particularly preferred is an acryl-based pressure-sensitive adhesive or any other pressure-sensitive adhesive having an excellent optical transparency and an appropriate wettability and showing pressure-sensitive adhesive properties of cohesiveness and adhesion to give weather resistance, heat resistance and other properties.

Any appropriate method may be used to form a pressure-sensitive adhesive layer or layers on one or both sides of the polarizing or optical film. For example, such a method may include dissolving or dispersing a base polymer or a composition thereof in a suitable single solvent such as toluene or ethyl acetate or a mixture thereof to prepare an about 10 to 40% by weight pressure-sensitive adhesive solution and directly applying the solution to the polarizing or optical film by any suitable spreading method such as casting or coating, or may include forming a pressure-sensitive adhesive layer on a separator similarly to the above method and transferring it onto the polarizing or optical film.

The pressure-sensitive adhesive layer may also be formed as a laminate of layers different in composition, type or other properties on one or both sides of the polarizing or optical film. When pressure-sensitive adhesive layers are provided on both sides, they may be different in composition, type, thickness, or other properties between the front and back sides of the polarizing or optical film. The thickness of the pressure-sensitive adhesive layer is generally from 1 to 500 μm, preferably from 5 to 200 μm, more preferably from 10 to 100 μm, and it may be appropriately determined depending on the purpose of use, adhering strength, or other factors.

The liquid crystal display device is generally formed, for example, by fabricating appropriately a liquid crystal cell (having a structure of “glass substrate/liquid crystal layer/glass substrate”), polarizing films arranged at both sides thereof, respectively, and optional constituents such as a lighting system, and then incorporating a driving circuit to the fabricated body. The liquid crystal cell may be of any type, such as a TN type, STN type, π type, VA type, or IPS type. Moreover, this liquid crystal display device may be rendered an appropriate display device having a lighting system in which a backlight or reflector is used. When the liquid crystal display device is formed, one or more appropriate members may be arranged in the form of one or more layers at one or more appropriate positions of the device. Examples of the member (s) include a diffusion plate, an antiglare layer, an anti-reflection layer, a protective plate, a prism array, a lens array sheet, a light diffusion plate, and a backlight.

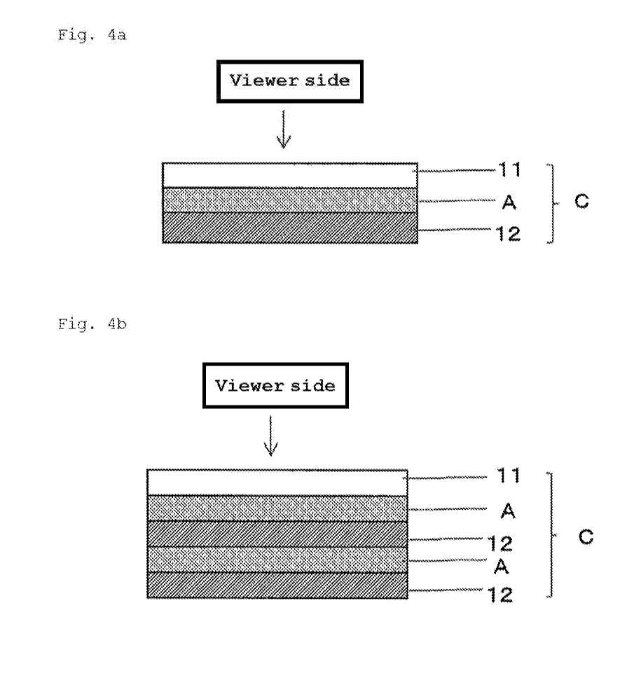

FIGS. 4a and 4b are cross-sectional views schematically showing typical examples of a touch panel C. The touch panel C of FIG. 4a is a capacitive touch panel including a transparent substrate 11, a transparent resin layer A, and a transparent conductive film 12 stacked in this order. The transparent conductive film 12 may include a stack of two or more layers. FIG. 4b shows a case where a capacitive touch panel C has a laminate including two transparent conductive films 12. In this case, the capacitive touch panel C includes a transparent substrate 11, a transparent resin layer A, a transparent conductive film 12, a transparent resin layer A, and a transparent conductive film 12 stacked in this order. In this way, the transparent resin layer A of the invention may be used as an inner component of a touch panel. The transparent substrate 11 may have a sensor layer. The transparent substrate 11 may be a cover glass, a plastic cover, or any other member, which may be used alone in an image display device (liquid crystal display device). In addition, a hard coat film (not shown) may also be provided on the transparent conductive film 12 on the side opposite to the transparent substrate 11 of the touch panel C typically shown in FIG. 4a or 4b.

The transparent substrate may be a glass plate or a transparent acrylic plate (PMMA plate). The transparent substrate is the so-called cover glass, and is usable as a decorative panel. The transparent conductive film is preferably a film in which a transparent conductive film is laid on a glass plate or transparent plastic film (in particular, a PET film). The transparent conductive film may be a thin film made of a metal, a metal oxide, or a mixture of the two, and is, for example, a thin film of ITO (indium tin oxide), ZnO, SnO, or CTO (cadmium tin oxide). The thickness of the transparent conductive film is not particularly limited, and may be from about 10 to 200 nm. A typical example of the transparent conductive film is an ITO film in which an ITO membrane is laid on a PET film. The transparent conductive film may be laid through an undercoat layer onto any member. Plural undercoat layers may be laid. An oligomer-shift preventing layer may be laid between the transparent plastic film substrate and the pressure-sensitive adhesive layer. The hard coat film is preferably a film in which a transparent plastic film such as a PET film is subjected to hard coat treatment.

Some examples of the structure of the image display device having the transparent resin layer A of the invention are shown below.

A structure including the transparent substrate 11, the transparent resin layer (pressure-sensitive adhesive layer) A, the transparent conductive film 12, a pressure-sensitive adhesive layer (or pressure-sensitive adhesive sheet), a transparent conductive film, the transparent resin layer (pressure-sensitive adhesive layer) A, and the liquid crystal display device (LCD) B stacked in this order.

A structure including the transparent substrate 11 (having a transparent conductive thin coating such as an ITO thin coating (a sensor)), the transparent resin layer (pressure-sensitive adhesive layer) A, the transparent conductive film 12, the transparent resin layer (pressure-sensitive adhesive layer) A, and the liquid crystal display device (LCD) B stacked in this order.

A structure including the transparent substrate 11 (having a transparent conductive thin coating such as an ITO thin coating (a sensor)), the transparent resin layer (pressure-sensitive adhesive layer) A, and the liquid crystal display device (LCD) B stacked in this order.

A structure including the transparent substrate 11, the transparent resin layer (pressure-sensitive adhesive layer) A, a circularly polarizing film, the transparent resin layer (pressure-sensitive adhesive layer) A, a touch sensor, and the organic EL display device (OLED) B stacked in this order.

A structure including the transparent substrate 11, the transparent resin layer (pressure-sensitive adhesive layer) A, a touch sensor, the transparent resin layer (pressure-sensitive adhesive layer) A, a touch sensor, and the liquid crystal display device (LCD) B stacked in this order.

A structure including the transparent substrate 11, the transparent resin layer (pressure-sensitive adhesive layer) A, a touch sensor, and the liquid crystal display device (LCD) B stacked in this order.

A structure including the transparent substrate 11, the transparent resin layer (pressure-sensitive adhesive layer) A, a touch sensor, the transparent resin layer (pressure-sensitive adhesive layer) A, and the liquid crystal display device (LCD) B stacked in this order.

A structure including the transparent substrate 11, the transparent resin layer (pressure-sensitive adhesive layer) A, the in-cell type liquid crystal display device (liquid crystal display device (LCD) with a built-in in-cell touch sensor) B, and the polarizing film 1 stacked in this order.

A structure including the transparent substrate 11, the transparent resin layer (pressure-sensitive adhesive layer) A, and the on-cell type liquid crystal display device (liquid crystal display device (LCD) with a built-in on-cell touch sensor) B stacked in this order.

These are mere examples of the preferable layered structure and should not be construed as limiting the scope of the invention. In each of these structures, at least one of the transparent resin layers A is according to the invention. In the examples of the structure shown above, the transparent resin layer A is a pressure-sensitive adhesive layer. Alternatively, the transparent resin layer A may be made from a transparent liquid resin.

Hereinafter, the transparent resin layer of the invention will be described. The transparent resin layer of the invention has a surface resistance of 1.0×10¹³Ω/□ or less. Its surface resistance is preferably from 1.0×10⁸Ω/□ to 1.0×10¹³Ω/□, more preferably from 1.0×10⁹Ω/□ to 1.0×10¹²Ω/□, even more preferably from 5.0×10⁹Ω/□ to 5.0×10¹¹Ω/□. When the transparent resin layer satisfying the surface resistance requirement is placed (more on the viewer side than the most view side polarizing film) in an image display device, a suitable level of antistatic function can be imparted to a touch panel or any other device without degrading the performance of the image display device.

Concerning the transparent resin layer of the invention, the term “transparent” means that the resin layer has a measured haze value of 2% or less when having a thickness of 25 μm. The haze value is preferably 0 to 1.5%, more preferably 0 to 1%.

The transparent resin layer of the invention preferably has a thickness of 5 μm to 1 mm. The thickness of the transparent resin layer may be designed as appropriate depending on the place where the transparent resin layer is to be used. The thickness of the transparent resin layer is preferably from 10 μm to 500 μm, more preferably from 20 μm to 300 μm.

The transparent resin layer of the invention also preferably a value (volume resistivity) of 1.0×10¹² Ω·cm or less, more preferably 1.0×10⁷ Ω·cm or less, even more preferably 1.0×10⁶ Ω·cm or less, calculated by multiplying the surface resistance (Ω/□) by its thickness (cm).

A material for forming the transparent resin layer may be a material containing a base polymer that may be of various types. The type of the base polymer is not particularly limited, and examples thereof include rubber-based polymer, (meth)acryl-based polymer, silicone-based polymer, urethane-based polymer, vinyl alkyl ether-based polymer, polyvinyl alcohol-based polymer, polyvinyl pyrrolidone-based polymer, polyacrylamide-based polymer, and cellulose-based polymer.

It is preferred to use, out of these base polymers, any polymer that is excellent in optical transparency, and shows an appropriate wettability and adhesive properties of cohesiveness and adhesion to be excellent in weather resistance, heat resistance and other properties. A polymer showing such characteristics is preferably (meth)acryl-based polymer. Hereinafter, a typical example of the transparent resin layer for use as a pressure-sensitive adhesive layer will be described.

The (meth)acryl-based polymer is obtained by polymerizing one or more monomer components, the component(s) being/including an alkyl (meth)acrylate having an alkyl group of 4 to 24 carbon atoms at the ester end. As used herein, the term “alkyl (meth)acrylate” refers to alkyl acrylate and/or alkyl methacrylate, and “(meth)” is used in the same meaning in the description.

Examples of the alkyl (meth)acrylate include (meth)acrylates each having a linear or branched alkyl group of 4 to 24 carbon atoms. These alkyl (meth) acrylate may be used alone or in a mixture of two or more.

The alkyl (meth)acrylate is, for example, an alkyl (meth)acrylate having a branched alkyl group of 4 to 9 carbon atoms. This alkyl (meth)acrylate is preferred since the resultant polymer easily takes a good balance between adhesive properties. Examples thereof include n-butyl (meth)acrylate, s-butyl (meth)acrylate, t-butyl (meth)acrylate, isobutyl (meth)acrylate, n-pentyl (meth)acrylate, isopentyl (meth)acrylate, isohexyl (meth)acrylate, isoheptyl (meth)acrylate, 2-ethylhexyl (meth)acrylate, isooctyl (meth)acrylate, and isononyl (meth)acrylate. In the alkyl (meth)acrylate having a branched alkyl group of 6 to 9 carbon atoms, the alkyl group preferably has 7 to 9 carbon atoms, more preferably 8 to 9 carbon atoms.

In the invention, the content of the above-mentioned alkyl (meth)acrylate having an alkyl group of 4 to 24 carbon atoms at the ester end is 40% by weight or more, preferably 50% by weight or more, more preferably 60% by weight or more based on the total weight of the monofunctional monomer component used to form the (meth)acryl-based polymer. The use thereof in the content of 40% or more by weight is preferred since the resultant polymer easily takes a good balance between adhesive properties.

The monomer components for forming the (meth) acryl-based polymer in the invention may include, as a monofunctional monomer, a copolymerizable monomer other than the alkyl (meth)acrylate. The copolymerizable monomer is usable as a component other than the alkyl (meth)acrylate in the monomer components.

The copolymerizable monomers, for example, may include a cyclic nitrogen-containing monomer. Any monomer having a cyclic nitrogen structure and an unsaturated double bond-containing polymerizable functional group such as a (meth)acryloyl group or a vinyl group may be used without restriction as the cyclic nitrogen-containing monomer. The cyclic nitrogen structure preferably has a nitrogen atom in the cyclic structure. Examples of the cyclic nitrogen-containing monomer include vinyl lactam monomers such as N-vinylpyrrolidone, N-vinyl-∈-caprolactam, and methylvinylpyrrolidone; and nitrogen-containing heterocyclic vinyl monomers such as vinylpyridine, vinylpiperidone, vinylpyrimidine, vinylpiperazine, vinylpyrazine, vinylpyrrole, vinylimidazole, vinyloxazole, and vinylmorpholine. The cyclic nitrogen-containing monomer may also be a (meth)acrylic monomer having a heterocyclic ring such as a morpholine ring, a piperidine ring, a pyrrolidine ring, or a piperazine ring. Examples include N-acryloyl morpholine, N-acryloyl piperidine, N-methacryloyl piperidine, and N-acryloyl pyrrolidine. Among them, vinyl lactam monomers are preferred, in view of dielectric constant and cohesiveness.

In the invention, the content of the cyclic nitrogen-containing monomer is from 0.5 to 50% by weight, more preferably from 0.5 to 40% by weight, even more preferably from 0.5 to 30% by weight based on the total weight of the monomer component used to form the (meth) acryl-based polymer. The use of the cyclic nitrogen-containing monomer in the range is preferred for the control of the surface resistance value of the pressure-sensitive-adhesive-layer-attached polarizing film and, in particular, the compatibility of the monomer with an ionic compound when this compound is used in any one of the pressure sensitive adhesive layers, and the durability of the antistatic function of the film.

The monomer component used to form the (meth) acryl-based polymer according to the invention may further include a hydroxyl group-containing monomer as a monofunctional monomer. Any monomer having a hydroxyl group and an unsaturated double bond-containing polymerizable functional group such as a (meth)acryloyl group or a vinyl group may be used without restriction as the hydroxyl group-containing monomer. Examples of the hydroxyl group-containing monomer include hydroxyalkyl (meth)acrylate such as 2-hydroxyethyl (meth)acrylate, 2-hydroxypropyl (meth)acrylate, 2-hydroxybutyl (meth)acrylate, 3-hydroxypropyl (meth)acrylate, 4-hydroxybutyl (meth)acrylate, 6-hydroxyhexyl (meth)acrylate, 8-hydroxyoctyl (meth)acrylate, 10-hydroxydecyl (meth)acrylate, or 12-hydroxylauryl (meth)acrylate; and hydroxyalkylcycloalkane (meth)acrylate such as (4-hydroxymethylcyclohexyl)methyl (meth)acrylate. Other examples include hydroxyethyl(meth)acrylamide, allyl alcohol, 2-hydroxyethyl vinyl ether, 4-hydroxybutyl vinyl ether, and diethylene glycol monovinyl ether. These may be used alone or in any combination. Among them, hydroxyalkyl (meth)acrylate is preferred.

In the invention, the content of the hydroxyl group-containing monomer is preferably 1% by weight or more, more preferably 2% by weight or more, even more preferably 3% by weight or more, based on the total weight of the monofunctional monomers used to form the (meth)acryl-based polymer, in order to increase adhering strength and cohesive strength. On the other hand, if the content of the hydroxyl group-containing monomer is too high, a hard pressure-sensitive adhesive layer with low adhering strength can be formed, or the pressure-sensitive adhesive can have too high a viscosity or form a gel. Therefore, the content of the hydroxyl group-containing monomer is preferably 30% by weight or less, more preferably 27% by weight or less, even more preferably 25% by weight or less, based on the total weight of the monofunctional monomers used to form the (meth)acryl-based polymer.

The monomer component used to form the (meth) acryl-based polymer according to the invention may further include other functional group-containing monomers as a monofunctional monomer. The functional group-containing monomers include a carboxyl group-containing monomer, and a cyclic ether group-containing monomer.

Any monomer having a carboxyl group and an unsaturated double bond-containing polymerizable functional group such as a (meth)acryloyl group or a vinyl group may be used without restriction as the carboxyl group-containing monomer. Examples of the carboxyl group-containing monomer include (meth)acrylic acid, carboxyethyl (meth)acrylate, carboxypentyl (meth)acrylate, itaconic acid, maleic acid, fumaric acid, crotonic acid, and isocrotonic acid. These may be used alone or in any combination. Itaconic acid or maleic acid can be used in the form of an anhydride. Among these, acrylic acid and methacrylic acid are preferred, and acrylic acid is particularly preferred. In the invention, a carboxyl group-containing monomer may be or may not be used as an optional monomer to produce the (meth) acryl-based polymer. An adhesive containing a (meth) acryl-based polymer obtained from a monomer component free of any carboxyl group-containing monomer can form a pressure-sensitive adhesive layer with reduced ability to corrode metals, because the ability to corrode metals would be due to any carboxyl group.

Any monomer having a cyclic ether group such as an epoxy group or an oxetane group and an unsaturated double bond-containing polymerizable functional group such as a (meth)acryloyl group or a vinyl group may be used without restriction as the cyclic ether group-containing monomer. Examples of the epoxy group-containing monomer include glycidyl (meth)acrylate, 3,4-epoxycyclohexylmethyl (meth)acrylate, and 4-hydroxybutyl(meth)acrylate glycidyl ether. Examples of the oxetane group-containing monomer include 3-oxetanylmethyl (meth)acrylate, 3-methyl-oxetanylmethyl (meth)acrylate, 3-ethyl-oxetanylmethyl (meth)acrylate, 3-butyl-oxetanylmethyl (meth)acrylate, and 3-hexyl-oxetanylmethyl (meth)acrylate. These monomers may be used alone or in any combination.

In the invention, the content of the carboxyl group-containing monomer, and cyclic ether group-containing monomer is preferably 30% by weight or less, more preferably 27% by weight or less, further preferably 25% by weight or less, based on the total weight of the monofunctional monomer component used to form the (meth)acryl-based polymer.

An example of one of the monomer components for forming the (meth)acryl-based polymer in the invention is an alkyl (meth)acrylate, as the copolymerizable monomer, represented by CH₂═C(R¹) COOR² wherein R¹ represents hydrogen or a methyl group, and R² represents a unsubstituted or substituted alkyl group of 1 to 3 carbon atoms, or a cyclic alkyl group.

The unsubstituted or substituted alkyl group of 1 to 3 carbon atoms represented by R² may be a linear, or branched alkyl group. The substituted alkyl group preferably has an aryl group of 3 to 8 carbon atoms or an aryloxy group of 3 to 8 carbon atoms as a substituent. The aryl group is preferably, but not limited to, a phenyl group.

Examples of the monomer represented by CH₂═C(R¹)COOR² include methyl (meth)acrylate, ethyl (meth)acrylate, phenoxyethyl (meth)acrylate, benzyl (meth)acrylate, cyclohexyl (meth)acrylate, 3,3,5-trimethylcyclohexyl (meth)acrylate, and isobornyl (meth)acrylate. These monomers may be used alone or in any combination.

In the invention, the content of the (meth)acrylate represented by CH₂═C(R¹)COOR may be 50% by weight or less, preferably 45% by weight or less, more preferably 40% by weight or less, further more preferably 35% by weight or less, based on the total weight of the monofunctional monomer component used to form the (meth)acryl-based polymer.

Other copolymerizable monomers that may also be used include vinyl acetate, vinyl propionate, styrene, α-methylstyrene; glycol acrylic ester monomers such as polyethylene glycol (meth)acrylate, polypropylene glycol (meth)acrylate, methoxyethylene glycol (meth)acrylate, and methoxypolypropylene glycol (meth)acrylate; and acrylate ester monomers such as tetrahydrofurfuryl (meth)acrylate, fluoro(meth)acrylate, silicone (meth)acrylate, and 2-methoxyethyl acrylate; amide group-containing monomers, amino group-containing monomers, imide group-containing monomers, N-acryloyl morpholine, and vinyl ether monomers. Cyclic structure-containing monomers such as terpene (meth)acrylate and dicyclopentanyl (meth)acrylate may also be used as copolymerizable monomers.

Besides the above, a silicon atom-containing silane monomer may be exemplified as the copolymerizable monomer.

Examples of the silane monomers include 3-acryloxypropyltriethoxysilane, vinyltrimethoxysilane, vinyltriethoxysilane, 4-vinylbutyltrimethoxysilane, 4-vinylbutyltriethoxysilane, 8-vinyloctyltrimethoxysilane, 8-vinyloctyltriethoxysilane, 10-methacryloyloxydecyltrimethoxysilane, 10-acryloyloxydecyltrimethoxysilane, 10-methacryloyloxydecyltriethoxysilane, and 10-acryloyloxydecyltriethoxysilane.

In the invention, if necessary, the monomer component used to form the (meth)acryl-based polymer may contain a polyfunctional monomer for controlling the cohesive strength of the pressure-sensitive adhesive in addition to the monofunctional monomers listed above.

The polyfunctional monomer is a monomer having at least two polymerizable functional groups with an unsaturated double bond such as (meth)acryloyl group or vinyl group, and examples thereof include ester compounds of a polyhydric alcohol with (meth)acrylic acid such as (poly)ethylene glycol di(meth)acrylate, (poly)propylene glycol di(meth)acrylate, neopentyl glycol di(meth)acrylate, pentaerythritol di(meth)acrylate, pentaerythritol tri(meth)acrylate, dipentaerythritol hexa(meth)acrylate, 1,2-ethyleneglycol di(meth)acrylate, 1,6-hexanediol di(meth)acrylate, 1,12-dodecanediol di(meth)acrylate, trimethylolpropane tri(meth)acrylate, tetramethylolmethane tri(meth)acrylate; allyl (meth)acrylate, vinyl (meth)acrylate, divinylbenzene, epoxy acrylate, polyester acrylate, urethane acrylate, butyl di(meth)acrylate, hexyl di(meth)acrylate, and the like. Among them, trimethylolpropane tri(meth)acrylate, hexanediol di(meth)acrylate, and dipentaerythritol hexa(meth)acrylate can be preferably used. The polyfunctional monomer can be used alone or in combination of two or more.

The use amount of the polyfunctional monomer is varied in accordance with the molecular weight thereof and the number of functional groups thereof, and is preferably 3 parts by weight or less, more preferably 2 parts by weight or less, even more preferably 1 part by weight or less based on 100 parts by weight of the whole of the monofunctional monomer(s). The low limit value thereof is not particularly limited, and is preferably 0 part by weight or more, more preferably 0.001 part by weight or more. When the use amount of the polyfunctional monomer is in the range, the layers can be improved in adhering strength.

The (meth)acryl-based polymer described above can be produced using a method appropriately selected from known production methods, such as solution polymerization, radiation polymerization such as ultraviolet ray polymerization, bulk polymerization, and various radical polymerization methods including emulsion polymerization. The resultant (meth)acryl-based polymer may be any of a random copolymer, a block copolymer, a graft copolymer, or any other form.

Any appropriate polymerization initiator, chain transfer agent, emulsifying agent and so on may be selected and used for radical polymerization. The weight average molecular weight of the (meth)acryl-based polymer may be controlled by the reaction conditions including the amount of addition of the polymerization initiator or the chain transfer agent. The amount of the addition may be controlled as appropriate depending on the type of these materials.

In a solution polymerization process and so on, for example, ethyl acetate, toluene or the like is used as a polymerization solvent. In a specific solution polymerization process, for example, the reaction is performed under a stream of inert gas such as nitrogen at a temperature of about 50 to about 70° C. for about 5 to about 30 hours in the presence of a polymerization initiator.

Examples of the thermal polymerization initiator used for the solution polymerization process and so on include, but are not limited to, azo initiators such as 2,2′-azobisisobutyronitrile, 2,2′-azobis-2-methylbutyronitrile, 2,2′-azobis(2-methylpropionic acid) dimethyl, 4,4′-azobis-4-cyanovaleric acid, azobisisovaleronitrile, 2,2′-azobis(2-amidinopropane)dihydrochloride, 2,2′-azobis[2-(5-methyl-2-imidazoline-2-yl)propane]dihydrochloride, 2,2′-azobis(2-methylpropionamidine)disulfate, 2,2′-azobis(N,N′-dimethyleneisobutylamidine), and 2,2′-azobis[N-(2-carboxyethyl)-2-methylpropionamidine]hydrate (VA-057, manufactured by Wako Pure Chemical Industries, Ltd.); persulfates such as potassium persulfate and ammonium persulfate; peroxide initiators such as di(2-ethylhexyl)peroxydicarbonate, di(4-tert-butylcyclohexyl)peroxydicarbonate, di-sec-butylperoxydicarbonate, tert-butylperoxyneodecanoate, tert-hexylperoxypivalate, tert-butylperoxypivalate, dilauroyl peroxide, di-n-octanoyl peroxide, 1,1,3,3-tetramethylbutylperoxy-2-ethyl hexanoate, di(4-methylbenzoyl) peroxide, dibenzoyl peroxide, tert-butylperoxyisobutylate, 1,1-di(tert-hexylperoxy)cyclohexane, tert-butylhydroperoxide, and hydrogen peroxide; and redox system initiators of a combination of a peroxide and a reducing agent, such as a combination of a persulfate and sodium hydrogen sulfite and a combination of a peroxide and sodium ascorbate.

One of the above polymerization initiators may be used alone, or two or more thereof may be used in a mixture. The total content of the polymerization initiator is preferably from about 0.005 to 1 part by weight, more preferably from about 0.02 to about 0.5 parts by weight, based on 100 parts by total weight of the monomer component.

For example, when 2,2′-azobisisobutyronitrile is used as a polymerization initiator for the production of the (meth)acryl-based polymer with the above weight average molecular weight, the polymerization initiator is preferably used in a content of from about 0.06 to about 0.2 parts by weight, more preferably of from about 0.08 to about 0.175 parts by weight, based on 100 parts by total weight of the monomer component.

Examples of the chain transfer agent include lauryl mercaptan, glycidyl mercaptan, mercaptoacetic acid, 2-mercaptoethanol, thioglycolic acid, 2-ethylhexyl thioglycolate and 2,3-dimercapto-1-propanol. One of these chain transfer agents may be used alone, or two or more thereof may be used in a mixture. The total content of the chain transfer agent is preferably about 0.1 parts by weight or less, based on 100 parts by total weight of the monomer component.

Examples of the emulsifier used in emulsion polymerization include anionic emulsifiers such as sodium lauryl sulfate, ammonium lauryl sulfate, sodium dodecylbenzenesulfonate, ammonium polyoxyethylene alkyl ether sulfate, and sodium polyoxyethylene alkyl phenyl ether sulfate; and nonionic emulsifiers such as polyoxyethylene alkyl ether, polyoxyethylene alkyl phenyl ether, polyoxyethylene fatty acid ester, and polyoxyethylene-polyoxypropylene block polymers. These emulsifiers may be used alone, or two or more thereof may be used in combination.

The emulsifier may be a reactive emulsifier. Examples of such an emulsifier having an introduced radical-polymerizable functional group such as a propenyl group and an allyl ether group include AQUALON HS-10, HS-20, KH-10, BC-05, BC-10, and BC-20 (each manufactured by Dai-ichi Kogyo Seiyaku Co., Ltd.) and ADEKA REASOAP SEION (manufactured by ADEKA COORPORATION). The reactive emulsifier is preferred, because after polymerization, it can be incorporated into a polymer chain to improve water resistance. Based on 100 parts by total weight of the monomer component, the emulsifier is preferably used in a content of 0.3 to 5 parts by weight, more preferably of 0.5 to 1 part by weight, in view of polymerization stability or mechanical stability.

When the (meth)acryl-based polymer is produced by radiation polymerization, the production can be attained by irradiating the monomer component(s) with a radial ray, such as an electron beam or an ultraviolet ray, to be polymerized. When the radiation polymerization is attained using the electron beam, it is not particularly necessary to incorporate a photopolymerization initiator into the monomer component (s). When the radiation polymerization is attained through the ultraviolet ray polymerization, a photopolymerization initiator may be incorporated into the monomer component(s) to produce, particularly, an advantage of shortening the polymerization period, and/or some other advantage. The photopolymerization initiator may be used alone or in a mixture of two or more.

The photopolymerization initiator is not particularly limited as long as it can initiate photopolymerization, and photopolymerization initiators that are usually used can be employed. Examples thereof that can be used include benzoin ether-based photopolymerization initiator, acetophenone-based photopolymerization initiator, α-ketol-based photopolymerization initiator, aromatic sulfonyl chloride-based photopolymerization initiator, photoactive oxime-based photopolymerization initiator, benzoin-based photopolymerization initiator, benzyl-based photopolymerization initiator, benzophenone-based photopolymerization initiator, ketal-based photopolymerization initiator, thioxanthone-based photopolymerization initiator, acylphosphine oxide-based photopolymerization initiator, and the like.

Specific examples of the benzoin ether-based photopolymerization initiator include benzoin methyl ether, benzoin ethyl ether, benzoin propyl ether, benzoin isopropyl ether, benzoin isobutyl ether, 2,2-dimethoxy-1,2-diphenylethan-1-one (trade name: IRGACURE 651, manufactured by BASF), anisole methyl ether, and the like.

Examples of the acetophenone-based photopolymerization initiator include 1-hydroxycyclohexyl phenyl ketone (trade name: IRGACURE 184, manufactured by BASF), 4-phenoxydichloroacetophenone, 4-t-butyl-dichloroacetophenone, 1-[4-(2-hydroxyethoxy)-phenyl]-2-hydroxy-2-methyl-1-propan-1-one (trade name: IRGACURE 2959, manufactured by BASF), 2-hydroxy-2-methyl-1-phenyl-propan-1-one (trade name: DAROCUR 1173, manufactured by BASF), methoxyacetophenone, and the like. Examples of the α-ketol-based photopolymerization initiator include 2-methyl-2-hydroxypropiophenone, 1-[4-(2-hydroxyethyl)-phenyl]-2-hydroxy-2-methylpropan-1-on e, and the like. Examples of the aromatic sulfonyl chloride-based photopolymerization initiator include 2-naphthalene sulfonyl chloride and the like. Examples of the photoactive oxime-based photopolymerization initiator include 1-phenyl-1,1-propanedione-2-(o-ethoxycarbonyl)-oxime, and the like.

Examples of the benzoin-based photopolymerization initiator include benzoin and the like. Examples of the benzyl-based photopolymerization initiator include benzyl and the like. Examples of the benzophenone-based photopolymerization initiators include benzophenone, benzoylbenzoic acid, 3,3′-dimethyl-4-methoxybenzophenone, polyvinyl benzophenone, α-hydroxycyclohexyl phenyl ketone, and the like. Examples of the ketal-based photopolymerization initiator include benzyl dimethyl ketal and the like. Examples of the thioxanthone-based photopolymerization initiator include thioxanthone, 2-chlorothioxanthone, 2-methylthioxanthone, 2,4-dimethylthioxanthone, isopropylthioxanthone, 2,4-dichlorothioxanthone, 2,4-diethylthioxanthone, isopropylthioxanthone, 2,4-diisopropylthioxanthone, dodecylthioxanthone and the like.

Examples of the acylphosphine-based photopolymerization initiator include bis(2,6-dimethoxybenzoyl)phenylphosphine oxide, bis(2,6-dimethoxybenzoyl)(2,4,4-trimethylpentyl)phosphine oxide, bis(2, 6-dimethoxybenzoyl)-n-butylphosphine oxide, bis(2,6-dimethoxybenzoyl)-(2-methylpropan-1-yl)phosphine oxide, bis(2,6-dimethoxybenzoyl)-(1-methylpropan-1-yl)phosphine oxide, bis(2, 6-dimethoxybenzoyl)-t-butylphosphine oxide, bis(2,6-dimethoxybenzoyl)cyclohexylphosphine oxide, bis(2,6-dimethoxybenzoyl)octylphosphine oxide, bis(2-methoxybenzoyl)(2-methylpropan-1-yl)phosphine oxide, bis(2-methoxybenzoyl)(1-methylpropan-1-yl)phosphine oxide, bis(2,6-diethoxybenzoyl)(2-methylpropan-1-yl)phosphine oxide, bis(2,6-diethoxybenzoyl)(1-methylpropan-1-yl)phosphine oxide, bis(2,6-dibutoxybenzoyl)(2-methylpropan-1-yl)phosphine oxide, bis(2,4-dimethoxybenzoyl)(2-methylpropan-1-yl)phosphine oxide, bis(2,4,6-trimethylbenzoyl)(2,4-dipentoxyphenyl)phosphine oxide, bis(2,6-dimethoxybenzoyl)benzylphosphine oxide, bis(2,6-dimethoxybenzoyl)-2-phenylpropylphosphine oxide, bis(2,6-dimethoxybenzoyl)-2-phenylethylphosphine oxide, bis(2,6-dimethoxybenzoyl)benzylphosphine oxide, bis(2,6-dimethoxybenzoyl)-2-phenylpropylphosphine oxide, bis(2,6-dimethoxybenzoyl)-2-phenylethylphosphine oxide, 2,6-dimethoxybenzoyl benzylbutylphosphine oxide, 2,6-dimethoxybenzoyl benzyloctylphosphine oxide, bis(2,4,6-trimethylbenzoyl)-2,5-diisopropylphenylphosphine oxide, bis(2,4,6-trimethylbenzoyl)-2-methylphenylphosphine oxide, bis(2,4,6-trimethylbenzoyl)-4-methylphenylphosphine oxide, bis(2,4,6-trimethylbenzoyl)-2,5-diethylphenylphosphine oxide, bis(2,4,6-trimethylbenzoyl)-2,3,5,6-tetramethylphenylphosphine oxide, bis(2,4,6-trimethylbenzoyl)-2,4-di-n-butoxyphenylphosphine oxide, 2,4,6-trimethylbenzoyl diphenylphosphine oxide, bis(2,6-dimethoxybenzoyl)-2,4,4-trimethylpentylphosphine oxide, bis(2,4,6-trimethylbenzoyl)isobutylphosphine oxide, 2,6-dimethoxybenzoyl-2,4,6-trimethylbenzoyl-n-butylphosphin e oxide, bis(2,4,6-trimethylbenzoyl)phenylphosphine oxide, bis(2,4,6-trimethylbenzoyl)-2,4-dibutoxyphenylphosphine oxide, 1,10-bis[bis(2,4,6-trimethylbenzoyl)phosphine oxide]decane, tri(2-methylbenzoyl)phosphine oxide, and the like.

The content of the photopolymerization initiator is not particularly limited, but is preferably 0.01 to 5 parts by weight, more preferably 0.05 to 3 parts by weight, furthermore preferably 0.05 to 1.5 parts by weight, and particularly preferably 0.1 to 1 part by weight, based on 100 parts by total weight of the monomer component.

If the photopolymerization initiator is used in an amount of less than 0.01 parts by weight, the polymerization reaction may be insufficient. If the photopolymerization initiator is used in an amount of more than 5 parts by weight, the photopolymerization initiator may absorb ultraviolet rays, so that ultraviolet rays may fail to reach the inside of the pressure-sensitive adhesive layer. In this case, the degree of polymerization may decrease, or a polymer with a lower molecular weight may be produced. This may cause the resulting pressure-sensitive adhesive layer to have lower cohesive strength, so that in the process of peeling off the pressure-sensitive adhesive layer from a film, the pressure-sensitive adhesive layer may partially remain on the film, which may make it impossible to reuse the film. The photopolymerization initiators may be used singly or in combination of two or more.

In the invention, the (meth)acryl-based polymer preferably has a weight average molecular weight of 400,000 to 2,500,000, more preferably 600,000 to 2,200,000. When the weight average molecular weight is more than 400,000, the pressure-sensitive adhesive layer can have satisfactory durability and can have a cohesive strength small enough to suppress adhesive residue. On the other hand, if the weight average molecular weight is more than 2,500,000, bonding ability or adhesive strength may tend to be lower. In this case, the pressure-sensitive adhesive may form a solution with too high a viscosity, which may be difficult to apply. As used herein, the term “weight average molecular weight” refers to a polystyrene-equivalent weight average molecular weight, which is determined using gel permeation chromatography (GPC). It should be noted that the molecular weight of the (meth)acryl-based polymer obtained by radiation polymerization would be difficult to measure.

<Measurement of Weight Average Molecular Weight>

The weight average molecular weight of the obtained (meth)acryl-based polymer was measured by gel permeation chromatography (GPC) as follows. The polymer sample was dissolved in tetrahydrofuran to form a 0.1% by weight solution. After allowed to stand overnight, the solution was filtered through a 0.45 μm membrane filter, and the filtrate was used for the measurement.

Analyzer: HLC-8120GPC manufactured by TOSOH CORPORATION

Columns:
(meth) acryl-based polymer: GM7000H_{XL}+GMH_{XL}+GMH_{XL}, manufactured by TOSOH CORPORATION,
aromatic-based polymer: G3000HXL+2000HXL+G1000HXL, manufactured by TOSOH CORPORATION

Column size: each 7.8 mmφ×30 cm, 90 cm in total

Eluent: tetrahydrofuran (concentration 0.1% by weight)

Flow rate: 0.8 ml/minute

Inlet pressure: 1.6 MPa

Detector: differential refractometer (RI)

Column temperature: 40° C.
Injection volume: 100 μl
Eluent: tetrahydrofuran
Detector: differential refractometer
Standard sample: polystyrene

The formation material (transparent pressure-sensitive adhesive) of the transparent resin layer (pressure-sensitive adhesive layer) of the invention may contain a crosslinking agent. Examples of the crosslinking agents include an isocyanate crosslinking agent, an epoxy crosslinking agent, a silicone crosslinking agent, an oxazoline crosslinking agent, an aziridine crosslinking agent, a silane crosslinking agent, an alkyl etherified melamine crosslinking agent, a metallic chelate crosslinking agent and a peroxide. Such crosslinking agents may be used alone or in combination of two or more. An isocyanate crosslinking agent or an epoxy crosslinking agent is preferably used as the crosslinking agent.

These crosslinking agents may be used alone or in a mixture of two or more. The total content of the crosslinking agent(s) is preferably 0.01 to 5 parts by weight, more preferably 0.01 to 4 parts by weight, even more preferably 0.02 to 3 parts by weight, based on 100 parts by weight of the (meth)acryl-based polymer.

The term “isocyanate crosslinking agent” refers to a compound having two or more isocyanate groups (which may include functional groups that are temporarily protected with an isocyanate blocking agent or by oligomerization and are convertible to isocyanate groups) per molecule.

Isocyanate crosslinking agents include aromatic isocyanates such as tolylene diisocyanate and xylene diisocyanate, alicyclic isocyanates such as isophorone diisocyanate, and aliphatic isocyanates such as hexamethylene diisocyanate.

More specifically, examples of isocyanate crosslinking agents include lower aliphatic polyisocyanates such as butylene diisocyanate and hexamethylene diisocyanate; alicyclic isocyanates such as cyclopentylene diisocyanate, cyclohexylene diisocyanate, and isophorone diisocyanate; aromatic diisocyanates such as 2,4-tolylene diisocyanate, 4,4′-diphenylmethane diisocyanate, xylylene diisocyanate, and polymethylene polyphenyl isocyanate; isocyanate adducts such as a trimethylolpropane-tolylene diisocyanate trimer adduct (trade name: CORONATE L, manufactured by NIPPON POLYURETHANE INDUSTRY CO., LTD.), a trimethylolpropane-hexamethylene diisocyanate trimer adduct (trade name: CORONATE HL, manufactured by NIPPON POLYURETHANE INDUSTRY CO., LTD.), and an isocyanurate of hexamethylene diisocyanate (trade name: CORONATE HX, manufactured by NIPPON POLYURETHANE INDUSTRY CO., LTD.); a trimethylolpropane adduct of xylylene diisocyanate (trade name: D110N, manufactured by Mitsui Chemicals, Inc.) and a trimethylolpropane adduct of hexamethylene diisocyanate (trade name: D160N, manufactured by Mitsui Chemicals, Inc.); polyether polyisocyanate and polyester polyisocyanate; adducts thereof with various polyols; and polyisocyanates polyfunctionalized with an isocyanurate bond, a biuret bond, an allophanate bond, or the like. In particular, aliphatic isocyanates are preferably used because of their high reaction speed.

These isocyanate crosslinking agents may be used alone or in a mixture of two or more. The total content of the isocyanate crosslinking agent(s) is preferably 0.01 to 5 parts by weight, more preferably 0.01 to 4 parts by weight, further more preferably 0.02 to 3 parts by weight, based on 100 parts by weight of the (meth)acryl-based polymer. The content may be appropriately determined taking into account cohesive strength, the ability to prevent delamination in a durability test, or other properties.

When an aqueous dispersion of a modified (meth) acryl-based polymer produced by emulsion polymerization is used, the isocyanate crosslinking agent does not have to be used. If necessary, however, a blocked isocyanate crosslinking agent may also be used in such a case, because the isocyanate crosslinking agent itself can easily react with water.

The term “epoxy crosslinking agent” refers to a polyfunctional epoxy compound having two or more epoxy groups per molecule. Examples of the epoxy crosslinking agent include bisphenol A, epichlorohydrin-type epoxy resin, ethylene glycol diglycidyl ether, N,N,N′,N′-tetraglycidyl-m-xylenediamine, diglycidylaniline, diamineglycidylamine, 1,3-bis(N,N-diglycidylaminomethyl)cyclohexane, 1,6-hexanediol diglycidyl ether, neopentyl glycol diglycidyl ether, ethylene glycol diglycidyl ether, propylene glycol diglycidyl ether, polyethylene glycol diglycidyl ether, polypropylene glycol diglycidyl ether, sorbitol polyglycidyl ether, glycerol polyglycidyl ether, pentaerythritol polyglycidyl ether, glycerine diglycidyl ether, glycerine triglycidyl ether, polyglycerol polyglycidyl ether, sorbitan polyglycidyl ether, trimethylolpropane polyglycidyl ether, diglycidyl adipate, diglycidyl o-phthalate, triglycidyl tris(2-hydroxyethyl) isocyanurate, resorcin diglycidyl ether, bisphenol-S diglycidyl ether, and epoxy resins having two or more epoxy groups in the molecule. The epoxy crosslinking agent may also be a commercially available product such as TETRAD-C (trade name) or TETRAD-X (trade name) manufactured by MITSUBISHI GAS CHEMICAL COMPANY, INC.

These epoxy crosslinking agents may be used alone or in a mixture of two or more. The total content of the epoxy crosslinking agent(s) is preferably 0.01 to 5 parts by weight, more preferably 0.01 to 4 parts by weight, further more preferably 0.02 to 3 parts by weight, based on 100 parts by weight of the (meth)acryl-based polymer. The content may be appropriately determined taking into account cohesive strength, the ability to prevent delamination in a durability test, or other properties.

Any peroxide crosslinking agents capable of generating active radical species by heating and promoting the crosslinking of the base polymer in the pressure-sensitive adhesive may be appropriately used. In view of workability and stability, a peroxide with a one-minute half-life temperature of 80° C. to 160° C. is preferably used, and a peroxide with a one-minute half-life temperature of 90° C. to 140° C. is more preferably used.

Examples of the peroxide for use in the invention include di(2-ethylhexyl) peroxydicarbonate (one-minute half-life temperature: 90.6° C.), di(4-tert-butylcyclohexyl) peroxydicarbonate (one-minute half-life temperature: 92.1° C.), di-sec-butyl peroxydicarbonate (one-minute half-life temperature: 92.4° C.), tert-butyl peroxyneodecanoate (one-minute half-life temperature: 103.5° C.), tert-hexyl peroxypivalate (one-minute half-life temperature: 109.1° C.), tert-butyl peroxypivalate (one-minute half-life temperature: 110.3° C.), dilauroyl peroxide (one-minute half-life temperature: 116.4° C.), di-n-octanoylperoxide (one-minute half-life temperature: 117.4° C.), 1,1,3,3-tetramethylbutylperoxy-2-ethyl hexanoate (one-minute half-life temperature: 124.3° C.), di(4-methylbenzoyl) peroxide (one-minute half-life temperature: 128.2° C.), dibenzoyl peroxide (one-minute half-life temperature: 130.0° C.), tert-butyl peroxyisobutylate (one-minute half-life temperature: 136.1° C.), and 1,1-di(tert-hexylperoxy)cyclohexane (one-minute half-life temperature: 149.2° C.). In particular, di(4-tert-butylcyclohexyl) peroxydicarbonate (one-minute half-life temperature: 92.1° C.), dilauroyl peroxide (one-minute half-life temperature: 116.4° C.), dibenzoyl peroxide (one-minute half-life temperature: 130.0° C.), or the like is preferably used, because they can provide high crosslinking reaction efficiency.

The half life of the peroxide is an indicator of how fast the peroxide can be decomposed and refers to the time required for the amount of the peroxide to reach one half of its original value. The decomposition temperature required for a certain half life and the half life time obtained at a certain temperature are shown in catalogs furnished by manufacturers, such as “Organic Peroxide Catalog, 9th Edition, May, 2003” furnished by NOF CORPORATION.

One of the peroxide crosslinking agents may be used alone, or a mixture of two or more of the peroxide crosslinking agent may be used. The total content of the peroxide(s) is preferably from 0.02 to 2 parts by weight, more preferably from 0.05 to 1 part by weight, based on 100 parts by weight of the (meth) acryl-based polymer. The content of the peroxide(s) may be appropriately selected in this range in order to control the workability, reworkability, crosslink stability or peeling properties.

The amount of decomposition of the peroxide may be determined by measuring the peroxide residue after the reaction process by high performance liquid chromatography (HPLC).

More specifically, for example, after the reaction process, about 0.2 g of each pressure-sensitive adhesive composition is taken out, immersed in 10 ml of ethyl acetate, subjected to shaking extraction at 25° C. and 120 rpm for 3 hours in a shaker, and then allowed to stand at room temperature for 3 days. Thereafter, 10 ml of acetonitrile is added, and the mixture is shaken at 25° C. and 120 rpm for 30 minutes. About 10 μl of the liquid extract obtained by filtration through a membrane filter (0.45 μm) is subjected to HPLC by injection and analyzed so that the amount of the peroxide after the reaction process is determined.

As the crosslinking agent, a polyfunctional metal chelate may also be used in combination with an organic crosslinking agent. Examples of the polyfunctional metal chelate may include a polyvalent metal and an organic compound that is covalently or coordinately bonded to the metal. Examples of the polyvalent metal atom include Al, Cr, Zr, Co, Cu, Fe, Ni, V, Zn, In, Ca, Mg, Mn, Y, Ce, Sr, Ba, Mo, La, Sn, and Ti. The organic compound has a covalent or coordinate bond-forming atom such as an oxygen atom. Examples of the organic compound include alkyl esters, alcohol compounds, carboxylic acid compounds, ether compounds, and ketone compounds.

The formation material (pressure-sensitive adhesive) of the transparent resin layer (pressure-sensitive adhesive layer) of the invention may contain a (meth)acryl-based oligomer in view of improving adhesive strength. The (meth)acryl-based oligomer is preferably a polymer having a Tg higher than that of the (meth)acryl-based polymer according to the invention and having a weight average molecular weight lower than that of the (meth)acryl-based polymer according to the invention. The (meth)acryl-based oligomer functions as a tackifying resin and is advantageous in increasing adhesive strength without raising dielectric constant.

The (meth) acryl-based oligomer may have a Tg of from about 0° C. to about 300° C., preferably from about 20° C. to about 300° C., more preferably from about 40° C. to about 300° C. If the Tg is lower than about 0° C., the pressure-sensitive adhesive layer may be lowered in cohesive strength at room temperature or higher so as to be lowered in holding performance or in tackiness at high temperatures. Like the Tg of the (meth)acryl-based polymer, the Tg of the (meth)acryl-based oligomer is the theoretical value calculated from the Fox equation.

The (meth) acryl-based oligomer may have a weight average molecular weight of 1,000 to less than 30,000, preferably 1,500 to less than 20,000, more preferably 2,000 to less than 10,000. If the oligomer has a weight average molecular weight of 30,000 or more, the effect of improving adhesive strength cannot be sufficiently obtained in some cases. The oligomer with a weight average molecular weight of less than 1,000 may lower the adhesive strength or holding performance because of its relatively low molecular weight. In the invention, the weight average molecular weight of the (meth) acryl-based oligomer can be determined as a polystyrene-equivalent weight average molecular weight by GPC method. More specifically, the weight average molecular weight can be determined using HPLC 8020 with two TSKgel GMH-H (20) columns manufactured by TOSOH CORPORATION under the conditions of a solvent of tetrahydrofuran and a flow rate of about 0.5 ml/minute.

Examples of monomers that may be used to form the (meth)acryl-based oligomer include alkyl (meth)acrylate such as methyl (meth)acrylate, ethyl (meth)acrylate, propyl (meth)acrylate, isopropyl (meth)acrylate, butyl (meth)acrylate, isobutyl (meth)acrylate, sec-butyl (meth)acrylate, tert-butyl (meth)acrylate, pentyl (meth)acrylate, isopentyl (meth)acrylate, hexyl (meth)acrylate, 2-ethylhexyl (meth)acrylate, heptyl (meth)acrylate, octyl (meth)acrylate, isooctyl (meth)acrylate, nonyl (meth)acrylate, isononyl (meth)acrylate, decyl (meth)acrylate, isodecyl (meth)acrylate, undecyl (meth)acrylate, or dodecyl (meth)acrylate; an ester of (meth)acrylic acid and an alicyclic alcohol, such as cyclohexyl (meth)acrylate, isobornyl (meth)acrylate or dicyclopentanyl (meth)acrylate; aryl (meth)acrylate such as phenyl (meth)acrylate or benzyl (meth)acrylate; and a (meth)acrylate derived from a terpene compound derivative alcohol. These (meth)acrylates may be used alone or in combination of two or more.

The (meth)acryl-based oligomer preferably contains, as a monomer unit, an acrylic monomer having a relatively bulky structure, typified by an alkyl (meth)acrylate whose alkyl group has a branched structure, such as isobutyl (meth)acrylate or tert-butyl (meth)acrylate; an ester of (meth)acrylic acid and an alicyclic alcohol, such as cyclohexyl (meth)acrylate, isobornyl (meth)acrylate or dicyclopentanyl (meth)acrylate; or aryl (meth)acrylate such as phenyl (meth)acrylate or benzyl (meth)acrylate, or any other cyclic structure-containing (meth)acrylate. The use of a (meth)acryl-based oligomer with such a bulky structure can further improve the tackiness of the pressure-sensitive adhesive layer. In terms of bulkiness, cyclic structure-containing oligomers are highly effective, and oligomers having two or more rings are more effective. When ultraviolet light is used in the process of synthesizing the (meth)acryl-based oligomer or forming the pressure-sensitive adhesive layer, a saturated oligomer is preferred because such an oligomer is less likely to inhibit polymerization, and an alkyl (meth)acrylate whose alkyl group has a branched structure or an ester of an alicyclic alcohol and (meth)acrylic acid is preferably used as a monomer to form the (meth)acryl-based oligomer.

From these points of view, preferred examples of the (meth)acryl-based oligomer include a copolymer of cyclohexyl methacrylate (CHMA) and isobutyl methacrylate (IBMA), a copolymer of cyclohexyl methacrylate (CHMA) and isobornyl methacrylate (IBXMA), a copolymer of cyclohexyl methacrylate (CHMA) and acryloyl morpholine (ACMO), a copolymer of cyclohexyl methacrylate (CHMA) and diethylacrylamide (DEAA), a copolymer of 1-adamanthyl acrylate (ADA) and methyl methacrylate (MMA), a copolymer of dicyclopentanyl methacrylate (DCPMA) and isobornyl methacrylate (IBXMA), dicyclopentanyl methacrylate (DCPMA), cyclohexyl methacrylate (CHMA), isobornyl methacrylate (IBXMA), isobornyl acrylate (IBXA), a copolymer of dicyclopentanyl methacrylate (DCPMA) and methyl methacrylate (MMA), and a homopolymer of each of dicyclopentanyl acrylate (DCPA), 1-adamanthyl methacrylate (ADMA), and 1-adamanthyl acrylate (ADA). In particular, an oligomer composed mainly of CHMA is preferred.

In the formation material (pressure-sensitive adhesive) of the transparent resin layer (pressure-sensitive adhesive layer) of the invention, the content of the (meth)acryl-based oligomer is preferably, but not limited to, 70 parts by weight or less, more preferably from 1 to 70 parts by weight, even more preferably from 2 to 50 parts by weight, still more preferably from 3 to 40 parts by weight, based on 100 parts by weight of the (meth)acryl-based polymer. If the content of the (meth)acryl-based oligomer is more than 70 parts by weight, a problem may occur such as an increase in elastic modulus or a decrease in tackiness at low temperature. Adding 1 part by weight or more of the (meth)acryl-based oligomer is effective in improving adhesive strength.

The formation material (pressure-sensitive adhesive) of the transparent resin layer (pressure-sensitive adhesive layer) of the invention may further contain a silane coupling agent for improving water resistance at the interface between the pressure-sensitive adhesive layer and a hydrophilic adherend, such as glass, bonded thereto. The content of the silane coupling agent is preferably 1 part by weight or less, more preferably from 0.01 to 1 part by weight, even more preferably from 0.02 to 0.6 parts by weight, based on 100 parts by weight of the (meth)acryl-based polymer. If the content of the silane coupling agent is too high, the adhesive may have a higher adhesive strength to glass so that it may be less removable from glass. If the content of the silane coupling agent is too low, the durability of the adhesive may undesirably decrease.

Examples of silane coupling agent preferably can be used include epoxy group-containing silane coupling agents such as 3-glycidoxypropyltrimethoxysilane, 3-glycidoxypropyltriethoxysilane, 3-glycidoxypropylmethyldiethoxysilane, and 2-(3,4-epoxycyclohexyl)ethyltrimethoxysilane; amino group-containing silane coupling agents such as 3-aminopropyltrimethoxysilane, N-(2-aminoethyl)-3-aminopropylmethyldimethoxysilane, 3-triethoxysilyl-N-(1,3-dimethylbutylidene)propylamine and N-phenyl-γ-aminopropyltrimethoxysilane; (meth)acrylic group-containing silane coupling agents such as 3-acryloxypropyltrimethoxysilane and 3-methacryloxypropyltriethoxysilane; and isocyanate group-containing silane coupling agents such as 3-isocyanatepropyltriethoxysilane.

In addition to the base polymer, the formation material (pressure-sensitive adhesive) of the transparent resin layer (pressure-sensitive adhesive layer) of the invention may contain an ionic compound for controlling the surface resistance of the transparent resin layer within the range according to the invention. The ionic compound to be used is preferably an alkali metal salt and/or an organic cation-anion salt. Any of organic and inorganic salts of alkali metals may be used as the alkali metal salt. As used herein, the term “organic cation-anion salt” refers to an organic salt including an organic cation moiety, in which the anion moiety may be organic or inorganic. The “organic cation-anion salt” is also referred to as the ionic liquid or the ionic solid.

<Alkali Metal Salt>

The cation moiety of the alkali metal salt includes an alkali metal ion, which may be any of lithium, sodium, and potassium ions. Among these alkali metal ions, lithium ion is particularly preferred.

The anion moiety of the alkali metal salt may include an organic material or an inorganic material. Examples of the anion moiety that may be used to form the organic salt include CH₃COO⁻, CF₃COO⁻, CH₃SO₃⁻, CF₃SO₃⁻, (CF₃SO₂)₃C⁻, C₄F₉SO₃⁻, C₃F₇COO⁻, (CF₃SO₂) (CF₃CO)N⁻, ⁻O₃S(CF₂)₃SO₃⁻, PF₆⁻, and CO₃²⁻, and those represented by the following general formulae (1) to (4):

(CₙF₂ₙ₊₁SO₂)₂N⁻, (1)

wherein n is an integer of 1 to 10;

CF₂(CₘF₂ₘSO₂)₂N⁻, (2)

wherein m is an integer of 1 to 10;

⁻O₃S(CF₂)₁SO₃⁻, (3)

wherein 1 is an integer of 1 to 10; and

(CₚF₂ₚ₊₁SO₂)N⁻(C_{q}F_{2q+1}SO₂), (4)

wherein p and q are each an integer of 1 to 10. In particular, a fluorine atom-containing anion moiety is preferably used because it can form an ionic compound with good ionic dissociation properties. Examples of the anion moiety that may be used to form the inorganic salt include Cl⁻, Br⁻, I⁻, AlCl₄⁻, Al₂Cl₇⁻, BF₄⁻, PF₆⁻, ClO₄⁻, NO₃⁻, AsF₆⁻, SbF₆⁻, NbF₆⁻, TaF₆⁻, and (CN)₂N⁻. The anion moiety is preferably (perfluoroalkylsulfonyl)imide represented by the general formula (1), such as (CF₃SO₂)₂N⁻ or (C₂F₅SO₂)₂N⁻, in particular, preferably (trifluoromethanesulfonyl)imide such as (CF₃SO₂)₂N⁻.

Examples of organic salts of alkali metals include sodium acetate, sodium alginate, sodium lignosulfonate, sodium toluenesulfonate, LiCF₃SO₃, Li(CF₃SO₂)₂N, Li(CF₃SO₂)₂N, Li(C₂F₅SO₂)₂N, Li(C₄F₉SO₂)₂N, Li(CF₃SO₂)₃C, KO₃S(CF₂)₃SO₃K, and LiO₃S(CF₂)₃SO₃K. Among them, LiCF₃SO₃, Li(CF₃SO₂)₂N, Li(C₂F₅SO₂)₂N, Li(C₄F₉SO₂)₂N, Li(CF₃SO₂)₃C, and the like are preferred, fluorine-containing lithium imide salts such as Li(CF₃SO₂)₂N, Li(C₂F₅SO₂)₂N, and Li(C₄F₉SO₂)₂N are more preferred, and (perfluoroalkylsulfonyl)imide lithium salt is particularly preferred.

Examples of inorganic salts of alkali metals include lithium perchlorate and lithium iodide.

<Organic Cation-Anion Salt>

The organic cation-anion salt that may be used in the invention includes a cationic component and an anionic component, in which the cationic component includes an organic material. Examples of the cationic component include a pyridinium cation, a piperidinium cation, a pyrrolidinium cation, a pyrroline skeleton-containing cation, a pyrrole skeleton-containing cation, an imidazolium cation, a tetrahydropyridinium cation, a dihydropyridinium cation, a pyrazolium cation, a pyrazolinium cation, a tetraalkylammonium cation, a trialkylsulfonium cation, and a tetraalkylphosphonium cation.

Examples of the anionic component that may be used include Cl⁻, Br⁻, I⁻, AlCl₄⁻, Al₂Cl₇⁻, BF₄⁻, PF₆⁻, ClO₄⁻, NO₃⁻, CH₃COO—, CF₃COO⁻, CH₃SO₃⁻, CF₃SO₃⁻, (CF₃SO₂)₃C⁻, AsF₆⁻, SbF₆⁻, NbF₆⁻, TaF₆⁻, (CN)₂N⁻, C₄F₉SO₃⁻, C₃F₇COO⁻, (CF₃SO₂) (CF₃CO)N⁻, and —O₃S(CF₂)₃SO₃⁻, and those represented by the following general formulae (1) to (4):

(CₙF₂ₙ₊₁SO₂)₂N⁻, (1)

wherein n is an integer of 1 to 10;

CF₂(CₘF₂ₘSO₂)₂N⁻, (2)

wherein m is an integer of 1 to 10;

⁻O₃S(CF₂)₁SO₃⁻, (3)

wherein 1 is an integer of 1 to 10; and

(CₚF₂ₚ₊₁SO₂)N⁻(CqF_{2q+1}SO₂), (4)

wherein p and q are each an integer of 1 to 10. In particular, a fluorine atom-containing anionic component is preferably used because it can form an ionic compound with good ionic dissociation properties.

Examples of the organic cation-anion salt that may be used include compounds appropriately selected from combinations of the above cationic and anionic components. Examples thereof include, such as 1-butylpyridinium tetrafluoroborate, 1-butylpyridinium hexafluorophosphate, 1-butyl-3-methylpyridinium tetrafluoroborate, 1-butyl-3-methylpyridinium trifluoromethanesulfonate, 1-butyl-3-methylpyridinium bis(trifluoromethanesulfonyl)imide, 1-butyl-3-methylpyridinium bis(pentafluoroethanesulfonyl)imide, 1-hexylpyridinium tetrafluoroborate, 2-methyl-1-pyrroline tetrafluoroborate, 1-ethyl-2-phenylindole tetrafluoroborate, 1,2-dimethylindole tetrafluoroborate, 1-ethylcarbazole tetrafluoroborate, 1-ethyl-3-methylimidazolium tetrafluoroborate, 1-ethyl-3-methylimidazolium acetate, 1-ethyl-3-methylimidazolium trifluoroacetate, 1-ethyl-3-methylimidazolium heptafluorobutyrate, 1-ethyl-3-methylimidazolium trifluoromethanesulfonate, 1-ethyl-3-methylimidazolium perfluorobutanesulfonate, 1-ethyl-3-methylimidazolium dicyanamide, 1-ethyl-3-methylimidazolium bis(trifluoromethanesulfonyl)imide, 1-ethyl-3-methylimidazolium bis(pentafluoroethanesulfonyl)imide, 1-ethyl-3-methylimidazolium tris(trifluoromethanesulfonyl)methide, 1-butyl-3-methylimidazolium tetrafluoroborate, 1-butyl-3-methylimidazolium hexafluorophosphate, 1-butyl-3-methylimidazolium trifluoroacetate, 1-butyl-3-methylimidazolium heptafluorobutyrate, 1-butyl-3-methylimidazolium trifluoromethanesulfonate, 1-butyl-3-methylimidazolium perfluorobutanesulfonate, 1-butyl-3-methylimidazolium bis(trifluoromethanesulfonyl)imide, 1-hexyl-3-methylimidazolium bromide, 1-hexyl-3-methylimidazolium chloride, 1-hexyl-3-methylimidazolium tetrafluoroborate, 1-hexyl-3-methylimidazolium hexafluorophosphate, 1-hexyl-3-methylimidazolium trifluoromethanesulfonate, 1-octyl-3-methylimidazolium tetrafluoroborate, 1-octyl-3-methylimidazolium hexafluorophosphate, 1-hexyl-2,3-dimethylimidazolium tetrafluoroborate, 1,2-dimethyl-3-propylimidazolium bis(trifluoromethanesulfonyl)imide, 1-metylpyrazolium tetrafluoroborate, 3-methylpyrazolium tetrafluoroborate, tetrahexylammoniumi bis(trifluoromethanesulfonyl)imide, diallyldimethylaumonium tetrafluoroborate, diallyldimethylammonium trifluoromethanesulfonate, dial lyldimethylammonium bis(trifluoromethanesulfonyl)imide, dial lyldimethylammonium bis(pentafluoroethanesulfonyl)imide, N,N-diethyl-N-methyl-N-(2-methoxyethyl) ammonium tetrafluoroborate, N, N-diethyl-N-methyl-N-(2-methoxyethyl) ammonium tri fluoromethanesulfonate, N, N-diethyl-N-methyl-N-(2-methoxyethyl) ammonium bis(trifluoromethanesulfonyl)imide, N, N-diethyl-N-methyl-N-(2-methoxyethyl) ammonium bis(pentafluoroethanesulfonyl)imide, glycidyltrimethylammonium trifluoromethanesulfonate, glycidyltrimiethylammnrium bis(trifluoromethaniesulfonyl)imide, glycidyl trimethylammonium bis(pentafluoroethanesulfonyl)imide, 1-butylpyridinium (trifluoromnethaniesulfoniyl)trifluoroacetamide, 1-butyl-3-mnethylpyridiniium (trifluoromnethaniesulfoniyl)trifluoroacetamide, 1-ethyl-3-methylimidazolium (trifluoromethanesulfonyl)trifluoroacetamnide, N,N-diethyl-N-methyl-N-(2-methoxyethyl)ammonium (trifluoromethanesulfonyl)trifluoroacetamide, diallyldimethylammonium (trifluoromethanesulfonyl)trifluoroacetamide, glycidyltrimethylammonium (trifluoromethanesulfonyl)trifluoroacetamide, N,N-dimethyl-N-ethyl-N-propylammonium bis(trifluoromethanesulfonyl)imide, N,N-dimethyl-N-ethyl-N-butylammonium bis(trifluoromethanesulfonyl)imide, N,N-dimethyl-N-ethyl-N-pentylammonium bis(trifluoromethanesulfonyl)imide, N,N-dimethyl-N-ethyl-N-hexylammonium bis(trifluoromethanesulfonyl)imide, N,N-dimethyl-N-ethyl-N-heptylammonium bis(trifluoromethanesulfonyl)imide, N,N-dimethyl-N-ethyl-N-nonylanmmonium bis(trifluoromethanesulfonyl)imide, N,N-dimethyl-N,N-dipropylammonium bis(trifluoromethanesulfonyl)imide, N,N-dimethyl-N-propyl-N-butylammonium bis(trifluoromethanesulfonyl)imide, N,N-dimethyl-N-propyl-N-pentylamnonium bis(trifluoromethanesulfonyl)imide, N,N-dimethyl-N-propyl-N-hexylammonium bis(trifluoromethanesulfonyl)imide, N,N-dimethyl-N-propyl-N-heptylammonium bis(trifluoromethanesulfonyl)imide, N,N-dimethyl-N-butyl-N-hexylammonium bis(trifluoromethanesulfonyl)imide, N,N-dimethyl-N-butyl-N-heptylammonium bis(trifluoromethanesulfonyl)imide, N,N-dimethyl-N-pentyl-N-hexylammonium bis(trifluoromethanesulfonyl)imide, N,N-dimethyl-N,N-dihexylammonium bis(trifluoromethanesulfonyl)imide, trimethylheptylammonium bis(trifluoromethanesulfonyl)imide, N,N-diethyl-N-methyl-N-propylammonium bis(trifluoromethanesulfonyl)imide, N,N-diethyl-N-methyl-N-pentylammonium bis(trifluoromethanesulfonyl)imide, N,N-diethyl-N-methyl-N-heptylammonium bis(trifluoromethanesulfonyl)imide, N,N-diethyl-N-propyl-N-pentylammonium bis(trifluoromethanesulfonyl)imide, triethylpropylammonium bis(trifluoromethanesulfonyl)imide, triethylpentylammonium bis(trifluoromethanesulfonyl)imide, triethylheptylammonium bis(trifluoromethanesulfonyl)imide, N,N-dipropyl-N-methyl-N-ethylammonium bis(trifluoromethanesulfonyl)imide, N,N-dipropyl-N-methyl-N-pentylammonium bis(trifluoromethanesulfonyl)imide, N,N-dipropyl-N-butyl-N-hexylammonium bis(trifluoromethanesulfonyl)imide, N,N-dipropyl-N,N-dihexylammonium bis(trifluoromethanesulfonyl)imide, N,N-dibutyl-N-methyl-N-pentylammonium bis(trifluoromethanesulfonyl)imide, N,N-dibutyl-N-methyl-N-hexylammonium bis(trifluoromethanesulfonyl)imide, trioctylmethylammonium bis(trifluoromethanesulfonyl)imide, N-methyl-N-ethyl-N-propyl-N-pentylammonium bis(trifluoromethanesulfonyl)imide, and 1-butyl-3-methylpyridine-1-ium trifluoromethanesulfonate. Commercially available products of the above may be used, examples of which include CIL-314 manufactured by Japan Carlit Co., Ltd. and ILA2-1 manufactured by KOEI CHEMICAL COMPANY LIMITED.

Examples thereof also include tetramethylammonium bis(trifluoromethanesulfonyl)imide, trimethylethylammonium bis(trifluoromethanesulfonyl)imide, trimethylbutylammonium bis(trifluoromethanesulfonyl)imide, trimethylpentylammonium bis(trifluoromethanesulfonyl)imide, trimethylheptylammonium bis(trifluoromethanesulfonyl)imide, trimethyloctylammonium bis(trifluoromethanesulfonyl)imide, tetraethylammonium bis(trifluoromethanesulfonyl)imide, triethylbutylammonium bis(trifluoromethanesulfonyl)imide, tetrabutylammonium bis(trifluoromethanesulfonyl)imide, and tetrahexylammonium bis(trifluoromethanesulfonyl)imide.

Examples thereof further include 1-dimethylpyrrolidinium bis(trifluoromethanesulfonyl)imide, 1-methyl-1-ethylpyrrolidinium bis(trifluoromethanesulfonyl)imide, 1-methyl-1-propylpyrrolidinium bis(trifluoromethanesulfonyl)imide, 1-methyl-1-butylpyrrolidinium bis(trifluoromethanesulfonyl)imide, 1-methyl-1-pentylpyrrolidinium bis(trifluoromethanesulfonyl)imide, 1-methyl-1-hexylpyrrolidinium bis(trifluoromethanesulfonyl)imide, 1-methyl-1-heptylpyrrolidinium bis(trifluoromethanesulfonyl)imide, 1-ethyl-1-propylpyrrolidinium bis(trifluoromethanesulfonyl)imide, 1-ethyl-1-butylpyrrolidinium bis(trifluoromethanesulfonyl)imide, 1-ethyl-1-pentylpyrrolidinium bis(trifluoromethanesulfonyl)imide, 1-ethyl-1-hexylpyrrolidinium bis(trifluoromethanesulfonyl)imide, 1-ethyl-1-heptylpyrrolidinium bis(trifluoromethanesulfonyl)imide, 1,1-dipropylpyrrolidinium bis(trifluoromethanesulfonyl)imide, 1-propyl-1-butylpyrrolidinium bis(trifluoromethanesulfonyl)imide, 1,1-dibutylpyrrolidinium bis(trifluoromethanesulfonyl)imide, 1-propylpiperidinium bis(trifluoromethanesulfonyl)imide, 1-pentylpiperidinium bis(trifluoromethanesulfonyl)imide, 1,1-dimethylpiperidinium bis(trifluoromethanesulfonyl)imide, 1-methyl-1-ethylpiperidinium bis(trifluoromethanesulfonyl)imide, 1-methyl-1-propylpiperidinium bis(trifluoromethanesulfonyl)imide, 1-methyl-1-butylpiperidinium bis(trifluoromethanesulfonyl)imide, 1-methyl-1-pentylpiperidinium bis(trifluoromethanesulfonyl)imide, 1-methyl-1-hexylpiperidinium bis(trifluoromethanesulfonyl)imide, 1-methyl-1-heptylpiperidinium bis(trifluoromethanesulfonyl)imide, 1-ethyl-1-propylpiperidinium bis(trifluoromethanesulfonyl)imide, 1-ethyl-1-butylpiperidinium bis(trifluoromethanesulfonyl)imide, 1-ethyl-1-pentylpiperidinium bis(trifluoromethanesulfonyl)imide, 1-ethyl-1-hexylpiperidinium bis(trifluoromethanesulfonyl)imide, 1-ethyl-1-heptylpiperidinium bis(trifluoromethanesulfonyl)imide, 1,1-dipropylpiperidinium bis(trifluoromethanesulfonyl)imide, 1-propyl-1-butylpiperidinium bis(trifluoromethanesulfonyl)imide, 1,1-dibutylpiperidinium bis(trifluoromethanesulfonyl)imide, 1,1-dimethylpyrrolidinium bis(pentafluoroethanesulfonyl)imide, 1-methyl-1-ethylpyrrolidinium bis(pentafluoroethanesulfonyl)imide, 1-methyl-1-propylpyrrolidinium bis(pentafluoroethanesulfonyl)imide, 1-methyl-1-butylpyrrolidinium bis(pentafluoroethanesulfonyl)imide, 1-methyl-1-pentylpyrrolidinium bis(pentafluoroethanesulfonyl)imide, 1-methyl-1-hexylpyrrolidinium bis(pentafluoroethanesulfonyl)imide, 1-methyl-1-heptylpyrrolidinium bis(pentafluoroethanesulfonyl)imide, 1-ethyl-1-propylpyrrolidinium bis(pentafluoroethanesulfonyl)imide, 1-ethyl-1-butylpyrrolidinium bis(pentafluoroethanesulfonyl)imide, 1-ethyl-1-pentylpyrrolidinium bis(pentafluoroethanesulfonyl)imide, 1-ethyl-1-hexylpyrrolidinium bis(pentafluoroethanesulfonyl)imide, 1-ethyl-1-heptylpyrrolidinium bis(pentafluoroethanesulfonyl)imide, 1,1-dipropylpyrrolidinium bis(pentafluoroethanesulfonyl)imide, 1-propyl-1-butylpyrrolidinium bis(pentafluoroethanesulfonyl)imide, 1,1-dibutylpyrrolidinium bis(pentafluoroethanesulfonyl)imide, 1-propylpiperidinium bis(pentafluoroethanesulfonyl)imide, 1-pentylpiperidinium bis(pentafluoroethanesulfonyl)imide, 1,1-dimethylpiperidinium bis(pentafluoroethanesulfonyl)imide, 1-methyl-1-ethylpiperidinium bis(pentafluoroethanesulfonyl)imide, 1-methyl-1-propylpiperidinium bis(pentafluoroethanesulfonyl)imide, 1-methyl-1-butylpiperidinium bis(pentafluoroethanesulfonyl)imide, 1-methyl-1-pentylpiperidinium bis(pentafluoroethanesulfonyl)imide, 1-methyl-1-hexylpiperidinium bis(pentafluoroethanesulfonyl)imide, 1-methyl-1-heptylpiperidinium bis(pentafluoroethanesulfonyl)imide, 1-ethyl-1-propylpiperidinium bis(pentafluoroethanesulfonyl)imide, 1-ethyl-1-heptylpiperidinium bis(pentafluoroethanesulfonyl)imide, 1-ethyl-1-pentylpiperidinium bis(pentafluoroethanesulfonyl)imide, 1-ethyl-1-hexylpiperidinium bis(pentafluoroethanesulfonyl)imide, 1-ethyl-1-heptylpiperidinium bis(pentafluoroethanesulfonyl)imide, 1-propyl-1-butylpiperidinium bis(pentafluoroethanesulfonyl)imide, 1,1-dipropylpiperidinium bis(pentafluoroethanesulfonyl)imide, and 1,1-dibutylpiperidinium bis(pentafluoroethanesulfonyl)imide.

Examples thereof further include derivatives of the above compounds, in which the cation moiety is replaced by trimethylsulfonium cation, triethylsulfonium cation, tributylsulfonium cation, trihexylsulfonium cation, diethylmethylsulfonium cation, dibutylethylsulfonium cation, dimethyldecylsulfonium cation, tetramethylphosphonium cation, tetraethylphosphonium cation, tetrabutylphosphonium cation, or tetrahexylphosphonium cation.

Examples thereof further include derivatives of the above compounds, in which bis(trifluoromethanesulfonyl)imide is replaced by bis(pentafluorosulfonyl)imide, bis(heptafluoropropanesulfonyl)imide, bis(nonafluorobutanesulfonyl)imide, trifluoromethanesulfonylnonafluorobutanesulfonylimide, heptafluoropropanesulfonyltrifluoromethanesulfonylimide, pentafluoroethanesulfonylnonafluorobutanesulfonylimide, or cyclo-hexafluoropropane-1,3-bis(sulfonyl)imide anion.

Besides the alkali metal salts and the organic cation-anion salts, examples of the ionic compound further include inorganic salts such as ammonium chloride, aluminum chloride, copper chloride, ferrous chloride, ferric chloride, and ammonium sulfate. These ionic compounds may be used alone or in combination of two or more.

The content of the ionic compound in the formation material (pressure-sensitive adhesive) of the transparent resin layer (pressure-sensitive adhesive layer) of the invention is preferably from 0.0001 to 5 parts by weight based on 100 parts by weight of the (meth)acryl-based polymer. If the content of the ionic compound is less than 0.0001 parts by weight, the ionic compound may be insufficiently effective in improving antistatic performance. The content of the ionic compound is preferably 0.01 parts by weight or more, more preferably 0.1 parts by weight or more. On the other hand, if the content of the ionic compound is more than 5 parts by weight, the transparent resin layer may have insufficient durability. The content of the ionic compound is preferably 3 parts by weight or less, more preferably 1 part by weigh or less. The upper limit or the lower limit may be used to determine a preferred range of the content of the ionic compound.

The formation material (pressure-sensitive adhesive) of the transparent resin layer (pressure-sensitive adhesive layer) of the invention may also contain any other known additive. For example, a polyether compound such as a polyalkylen glycol exemplified a polypropylene glycol, a powder such as a colorant and a pigment, a dye, a surfactant, a plasticizer, a tackifier, a surface lubricant, a leveling agent, a softening agent, an antioxidant, an age resister, a light stabilizer, an ultraviolet absorbing agent, a polymerization inhibitor, an inorganic or organic filler, a metal powder, or a particle- or foil-shaped material may be added as appropriate depending on the intended use. A redox system including an added reducing agent may also be used in the controllable range.

For example, the transparent resin layer (pressure-sensitive adhesive layer) may be formed by a method including applying the formation material (pressure-sensitive adhesive) to a member such as a transparent substrate and/or a polarizing film, removing the polymerization solvent and so on by drying to form a pressure-sensitive adhesive layers. Before the formation material is applied, appropriately at least one solvent other than the polymerization solvent may be added to the formation material.

Various methods may be used to apply the formation material. Specific examples of such methods include roll coating, kiss roll coating, gravure coating, reverse coating, roll brush coating, spray coating, dip roll coating, bar coating, knife coating, air knife coating, curtain coating, lip coating, and extrusion coating with a die coater or the like.

The heat drying temperature is preferably from 40° C. to 200° C., more preferably from 50° C. to 180° C., in particular, preferably from 70° C. to 170° C. Setting the heating temperature within the above range makes it possible to obtain a transparent resin layer having good adhesive properties. The drying time may be any appropriate period of time. The drying time is preferably from 5 seconds to 20 minutes, more preferably from 5 seconds to 10 minutes, in particular, preferably from 10 seconds to 5 minutes.

In order to form the transparent resin layer, the formation material (pressure-sensitive adhesive) may be polymerized by irradiation with active energy rays such as ultraviolet rays. Ultraviolet irradiation may be performed using a high-pressure mercury lamp, a low-pressure mercury lamp, or a metal halide lamp. When the formation material is a transparent pressure-sensitive adhesive, the (meth)acryl-based polymer and the transparent resin layer (pressure-sensitive adhesive layer) may be made from a monomer component. A crosslinking agent and other materials may be added as needed to the monomer component. Before use, the monomer component may be partially polymerized into a syrup form in advance of ultraviolet irradiation.

When the formation material is a transparent pressure-sensitive adhesive, the transparent resin layer (pressure-sensitive adhesive layer) may be formed on a support and then transferred onto a polarizing film or any other member. The support may be, for example, a release-treated sheet. A silicone release liner is preferably used as the release-treated sheet.

In the pressure-sensitive adhesive sheet having the transparent resin layer (pressure-sensitive adhesive layer) formed on the release-treated sheet, when the transparent resin layer (pressure-sensitive adhesive layer) is exposed, the transparent resin layer (pressure-sensitive adhesive layer) may be protected with the release-treated sheet (a separator) before practical use. The release-treated sheet is peeled off before actual use.

Examples of the material for forming the separator include a plastic film such as a polyethylene, polypropylene, polyethylene terephthalate, or polyester film, a porous material such as paper, cloth and nonwoven fabric, and an appropriate thin material such as a net, a foamed sheet, a metal foil, and a laminate thereof. In particular, a plastic film is preferably used, because of its good surface smoothness.

The plastic film may be any film capable of protecting the transparent resin layer (pressure-sensitive adhesive layer), and examples thereof include a polyethylene film, a polypropylene film, a polybutene film, a polybutadiene film, a polymethylpentene film, a polyvinyl chloride film, a vinyl chloride copolymer film, a polyethylene terephthalate film, a polybutylene terephthalate film, a polyurethane film, and an ethylene-vinyl acetate copolymer film.

The thickness of the separator is generally from about 5 to about 200 μm, preferably from about 5 to about 100 μm. If necessary, the separator may be treated with a release agent such as a silicone, fluorine, long-chain alkyl, or fatty acid amide release agent, or may be subjected to release and antifouling treatment with silica powder or to antistatic treatment of coating type, kneading and mixing type, vapor-deposition type, or the like. In particular, if the surface of the separator is appropriately subjected to release treatment such as silicone treatment, long-chain alkyl treatment, and fluorine treatment, the releasability from the transparent resin layer (pressure-sensitive adhesive layer) can be further increased.

The transparent resin layer may also be made from a transparent liquid resin. The transparent liquid resin may be, for example, an active energy ray-curable resin composition including a difunctional (meth)acrylate compound (component A) that is represented by formula (A) below and has two (meth)acryloyl groups.

R¹—O(X¹—O)ₘ—Y—(X²—O)ₙ—R₂ Formula (A):

In formula (A), R¹ and R² are each an acryloyl or methacryloyl group and may be the same or different, X¹ and X² are each an alkylene group of 2 to 4 carbon atoms and may be the same or different, m and n are each a positive integer, provided that m+n=3 to 40, and Y is a single bond, -Ph-C(CH₃)₂-Ph-O—, -Ph-CH₂-Ph-O—, or —C(CH₃)₂—O—, wherein -Ph- is a paraphenylene group.

Particularly, in formula (A), R¹ and R² are preferably methacryloyl groups so that high active energy ray-curability can be achieved. In formula (A), X¹ and X² are preferably alkylene groups of 3 to 4 carbon atoms so that high optical transparency can be achieved. In formula (A), m+n is preferably equal to 10 to 20 so that high optical transparency can be achieved.

In formula (A), X¹ and X² are preferably —CH(CH₃)—CH₂— and Y is preferably a single bond so that high optical transparency can be achieved.

The content of the specific (meth)acrylate compound (component A) is preferably set in the range of 0.1 to 50% by weight, more preferably in the range of 1 to 40% by weight, based on the total weight of the active energy ray-curable resin composition. Specifically, if the content of the specific (meth)acrylate compound is too low, the active energy ray-curability will tend to be low, and on the other hand, if it is too high, the low curing shrinkage will tend to be degraded.

The active energy ray-curable resin composition containing the specific (meth)acrylate compound (component A) can be cured by exposure to radiation such as electron beams or ultraviolet rays. When exposure to radiation is performed using electron beams, the composition does not need to contain a photopolymerization initiator. When exposure to radiation is performed using ultraviolet rays, however, a photopolymerization initiator (component B) may be added to the composition. Such a photopolymerization initiator (component B) acts as an ultraviolet curing agent. Various photopolymerization initiators such as photoradical polymerization initiators may be used. In the invention, when a touch panel including a transparent electrode such as indium tin oxide (ITO) formed thereon is used in a liquid crystal display device, a photoradical polymerization initiator is more preferably used in order to prevent photopolymerization initiator-derived ions (particularly counter anions) from corroding ITO.

The photoradical polymerization initiator may be the same as that for ultraviolet polymerization which is performed to produce the acryl-based polymer for forming the transparent resin layer (pressure-sensitive adhesive layer). The content of the photopolymerization initiator is preferably set in the range of 0.1 to 20% by weight, more preferably in the range of 0.2 to 20% by weight, based on the total weight of the ultraviolet-curable resin composition. Specifically, if the content of the photopolymerization initiator is too low, the ultraviolet curability will tend to be low, and on the other hand, if it is too high, the optical transparency will tend to be low.

In the invention, the active energy ray-curable resin composition containing the specific (meth)acrylate compound (component A) may further contain, if necessary, a conjugated diene polymer (component C) having at least one (meth)acryloyl group per molecule on average, which is preferable in that high optical transparency can be achieved. The content of the component C is preferably set in the range of 0.1 to 50% by weight based on the total weight of the active energy ray-curable resin composition.

In order to provide high optical transparency, the conjugated diene polymer (component C) is preferably a polymer that includes at least one selected from the group consisting of polybutadiene, polyisoprene, and a copolymer of butadiene and isoprene and has at least one (meth)acryloyl group per molecule on average.

In the invention, the active energy ray-curable resin composition may further contain a monofunctional monomer other than the components described above. The monofunctional monomer is a monomer having one unsaturated double bond-containing polymerizable functional group such as a (meth)acryloyl group or a vinyl group. The monofunctional monomer is preferably a (meth)acrylate monomer having a (meth)acryloyl group.

Examples of the (meth)acrylate monomer include 2-ethylhexyl (meth)acrylate, n-butyl (meth)acrylate, isobutyl (meth)acrylate, tert-butyl (meth)acrylate, lauryl (meth)acrylate, alkyl (meth)acrylate, methoxyethyl (meth)acrylate, 2-hydroxyethyl (meth)acrylate, 2-hydroxypropyl (meth)acrylate, 2-hydroxybutyl (meth)acrylate, benzyl (meth)acrylate, phenyl (meth)acrylate, ethylene glycol di(meth)acrylate, diethylene glycol di(meth)acrylate, triethylene glycol di(meth)acrylate, hydroxyethyl (meth)acrylate, 1,3-butylene glycol di(meth)acrylate, 1,4-butylene glycol di(meth)acrylate, neopentylglycol di(meth)acrylate, 1,6-hexanediol di(meth)acrylate, dicyclopentenyloxyethyl (meth)acrylate, and norbornene (meth)acrylate. Examples other than these (meth)acrylates include phenoxyethyl (meth)acrylate (PO), phenoxypolyethylene glycol (meth)acrylate, 2-hydroxy-3-phenoxypropyl (meth)acrylate, cyclohexyl (meth)acrylate (CH), nonylphenol EO adduct (meth)acrylate, methoxytriethylene glycol (meth)acrylate, and tetrahydrofurfuryl (meth)acrylate. These compounds may be used alone or in combination of two or more.

In the invention, the content of the monofunctional monomer is preferably set in the range of 0 to 50% by weight based on the total weight of the active energy ray-curable resin composition. Specifically, if the content of the monofunctional monomer is too high, the low curing shrinkage will tend to be degraded.

Similarly to the transparent pressure-sensitive adhesive, the transparent liquid resin used to form the transparent resin layer may contain additional components such as a crosslinking agent, a (meth)acryl-based oligomer, a silane coupling agent, an ionic compound, and other known additives. The contents of the additional components in the transparent pressure-sensitive adhesive are shown above based on 100 parts by weight of the (meth)acryl-based polymer. The transparent liquid resin (active energy ray-curable resin composition) preferably contains the additional components in amounts similar to those in the transparent pressure-sensitive adhesive based on 100 parts by weight of the total of the transparent liquid resin.

In the invention, besides the components described above, if necessary, the active energy ray-curable resin composition may contain an anti-foaming agent, a surfactant, a colorant, an organic filler, various spacers, a tackifier or an adhesiveness imparting agent, or other materials, depending on the intended use. These materials may be used alone or in combination of two or more.

In the invention, the active energy ray-curable resin composition can be produced, for example, by mixing the specific (meth)acrylate compound (component A) with other components and mixing and kneading the components by stirring with a planetary centrifugal mixer or a glass stirring vessel.

In the invention, the active energy ray-curable resin composition obtained in this manner is turned into a cured product, for example, by ultraviolet irradiation with a UV lamp or the like. After the photo irradiation such as the ultraviolet irradiation, if necessary, the cured product may be subjected to post curing at a given temperature.

In the invention, the active energy ray-curable resin composition is preferably applied between a polarizing film (image display panel) and a viewer-side component of an image display device, such as an input device such as a touch panel, a cover glass, a plastic cover, or any other transparent substrate, in order to fill in the space between the polarizing film (image display panel) and the component. Specifically, for example, a necessary amount of the active energy ray-curable resin composition according to the invention is applied to the component, and then the component is aligned with and bonded to the polarizing film (image display panel) under normal pressure or vacuum. In this process, the resin composition is partially irradiated with active energy rays to be fixed temporarily while the distance between the polarizing film (image display panel) and the component is maintained by controlling the bonding pressure or the height. Subsequently, after appearance inspection is performed as needed, active energy ray irradiation is performed again to cure the active energy ray-curable resin composition, so that the desired image display device is obtained.

As mentioned above, the desired image display device can be produced by a process that includes applying the active energy ray-curable resin composition of the invention to fill in the space between the polarizing film (image display panel) and the component placed on the image display panel and then curing the active energy ray-curable resin composition by exposure to active energy rays. When a touch sensor is installed in the image display device, the desired image display device can be produced by a process that includes placing the touch sensor between the image display panel and a protective cover plate (a transparent substrate such as a cover glass or a plastic cover), applying the active energy ray-curable resin composition of the invention to fill in at least one of the space between the image display panel and the touch sensor and the space between the protective cover plate and the touch sensor, and then curing the active energy ray-curable resin composition by exposure to active energy rays.

### EXAMPLES

Hereinafter, the present invention will be specifically described by way of working examples thereof. However, the invention is not limited by the examples. In each of the examples, the wording “part (s)” and the symbol “%” represent part(s) by weight and % by weight, respectively. The following estimations were made on each of the items in Examples and so on.

### Example 1

<Preparation of Monomer Component for Use in Ultraviolet Polymerization>

A four-necked flask equipped with a stirring blade, a thermometer, a nitrogen gas inlet tube, and a condenser tube was charged with 70 parts by weight of 2-ethylhexyl acrylate (2EHA), 15 parts by weight of N-vinylpyrrolidone (NVP), 15 parts by weight of 4-hydroxybutyl acrylate (4HBA), 0.05 parts by weight of two photopolymerization initiators (IRGACURE 184 (trade name) manufactured by BASF), and 0.05 parts by weight of a photopolymerization initiator (IRGACURE 651 (trade name) manufactured by BASF), so that a monomer mixture was obtained. Subsequently, the monomer mixture was partially photo-polymerized by exposure to ultraviolet rays under a nitrogen atmosphere, so that a partially polymerized product (acryl-based polymer syrup) with a conversion of about 10% by weight was obtained.

After 0.01 parts by weight of trimethylolpropane triacrylate (TMPTA) was added to 100 parts by weight of the acryl-based polymer syrup, these materials were uniformly mixed to form a monomer component.

<Preparation of Transparent Resin Layer-Formation Material>

A transparent resin layer-formation material was prepared by further adding 1 part by weight of lithium bistrifluoromethanesulfonylamide (LiTFSA) as an ionic compound based on 100 parts by weight of the acryl-based polymer syrup.

<Preparation of Transparent Resin Layer by Ultraviolet Polymerization>

Subsequently, the transparent resin layer-formation material prepared as described above was applied to the release-treated surface of a one-side silicone release agent-treated polyethylene terephthalate film (separator film) so that a coating layer with a final thickness of 20 μm could be formed. Subsequently, the surface of the monomer component coating was covered with a one-side silicone release agent-treated polyethylene terephthalate film (separator film) in such a manner that the release-treated surface of the film was placed on the coating layer side. In this way, the monomer component coating layer was shielded from oxygen. The resulting coating layer-attached sheet was irradiated for 360 seconds with ultraviolet rays with an illuminance of 5 mW/cm² (as measured with TOPCON UVR-T1 having the maximum sensitivity at about 350 nm) from a chemical light lamp (manufactured by Toshiba Corporation), so that the coating layer was cured to form a transparent resin layer.

<<Production of Polarizing Film>>

An 80 μm-thick polyvinyl alcohol film was stretched to 3 times between rolls different in velocity ratio, while it was dyed in a 0.3% iodine solution at 30° C. for 1 minute. The film was then stretched to a total stretch ratio of 6 times, while it was immersed in an aqueous solution containing 4% of boric acid and 10% of potassium iodide at 60° C. for 0.5 minutes. The film was then washed by immersion in an aqueous solution containing 1.5% of potassium iodide at 30° C. for 10 seconds and then dried at 50° C. for 4 minutes to give a polarizer with a thickness of 20 μm. A 40 μm thick saponified triacetylcellulose films were bonded to both sides of the polarizer with a polyvinyl alcohol adhesive to form a polarizing film (hereinafter, the resultant film will be referred to as the polarizing film P1).

<Preparation of Pressure-Sensitive-Adhesive-Layer (Viewer Side)-Attached Polarizing Film P1>

The resulting transparent resin layer was used as a pressure-sensitive adhesive layer. The separator film on one side was peeled off from the resulting transparent resin layer. The transparent resin layer (pressure-sensitive adhesive layer) on the other side separator film was transferred onto the polarizing film P1 prepared as described above, so that a pressure-sensitive-adhesive-layer (viewer side)-attached polarizing film P1 was obtained.

### Examples 2 to 15 and Comparative Examples 1 to 5

Transparent resin layers were prepared by performing the same procedure as in Example 1, except that the type and composition ratio of the monofunctional monomers used to form the monomer component, the type and content of the ionic compound, and the thickness of the transparent resin layer formed were changed as shown in Table 1. Pressure-sensitive-adhesive-layer (viewer side)-attached polarizing films P1 were also prepared as in Example 1.

The transparent resin layers (pressure-sensitive adhesive layers) or the pressure-sensitive-adhesive-layer (viewer side)-attached polarizing films P1 obtained in the Examples and the Comparative Examples were evaluated as described below. Table 1 shows the evaluation results.

<Surface Resistance>

The separator film on one side was peeled off from the transparent resin layer obtained in each Example. The exposed surface of the transparent resin layer was then measured for surface resistance (Ω/□) using MCP-HT450 manufactured by Mitsubishi Chemical Analytech Co., Ltd.

<Durability>

The separator of the pressure-sensitive adhesive-layer(viewer-side)-attached polarizing film P1 yielded in each of the above-mentioned Examples was peeled, and then bonded onto a non-alkali glass having a thickness of 0.7 mm (1737, manufactured by Corning Inc.), using a laminator. Next, the resultants were each subjected to autoclave treatment at 50° C. and 0.5 MPa for 15 minutes to cause the pressure-sensitive adhesive-layer-attached polarizing film to adhere closely onto the non-alkali glass. Next, a vacuum bonding device manufactured by Lantech Inc. was used to vacuum-bond these members onto each other at a pressure of 0.2 MPa and a vacuum degree of 30 Pa. The resultant samples were put into a 80° C. heating-oven (heated) and a 60° C./90%-RH thermostat (humidified), respectively. After 500 hours, the respective durabilities of the samples were evaluated by determining whether or not their polarizing film was peeled in accordance with the following criterion:

⊙: no peel was recognized.

◯: such a peel that was unable to be visually recognized was present.

Δ: such a slight peel that was able to be visually recognized was present.

x: a

clear peel was recognized.

<Measurement of Haze>

The transparent resin layer obtained in each Example was attached to one side of a non-alkali glass sheet with a total light transmittance of 93.3% and a haze of 0.1%. The haze of the resulting laminate was measured with a haze meter (MR-100, manufactured by Murakami Color Research Laboratory). In the measurement with the haze meter, the transparent resin layer was placed on the light source side. Since the non-alkali glass sheet had a haze of 0.1%, the haze of the transparent resin layer was calculated by subtracting 0.1% from the measured value. The total light transmittance (%) used was the measured value.

<ESD Gun Test (Evaluation of Static Electricity-Induced Unevenness)>

<<Preparation of Pressure-Sensitive-Adhesive-Layer (Cell Side)-Attached Polarizing Film P1>>

A reaction vessel equipped with a condenser tube, a nitrogen inlet tube, a thermometer, and a stirrer was charged with a monomer mixture containing 99 parts of butyl acrylate and 1 part of 4-hydroxybutyl acrylate. Based on 100 parts (solid basis) of the monomer mixture, 0.1 parts of 2,2′-azobisisobutyronitrile as a polymerization initiator was added together with ethyl acetate to the monomer mixture. Nitrogen gas was introduced to replace the air in the vessel while the mixture was gently stirred. The mixture was then subjected to a polymerization reaction for 7 hours while the temperature of the liquid in the flask was kept at around 60° C. Subsequently, ethyl acetate was added to the resulting reaction liquid, so that a solution of acryl-based polymer (A) with a weight average molecular weight of 1,600,000 was obtained with an adjusted solid concentration of 30%. Based on 100 parts of the solid in the resulting acryl-based polymer (A) solution, 0.1 parts of trimethylolpropane xylylene diisocyanate (Takenate D110N manufactured by Mitsui Chemicals, Inc.), 0.3 parts of dibenzoyl peroxide, and 0.2 parts of γ-glycidoxypropylmethoxysilane (KBM-403 manufactured by Shin-Etsu Chemical Co., Ltd.) were added as crosslinking agents to the polymer (A) solution, so that a pressure-sensitive adhesive composition solution was obtained.

The prepared pressure-sensitive adhesive composition was then uniformly applied to the release-treated surface of a one-side silicone release agent-treated polyethylene terephthalate film (separator film) so that a coating with a final thickness of 20 μm could be formed. The coating was then dried in an air circulation-type thermostatic oven at 150° C. for 60 seconds, so that a 20-μm-thick pressure-sensitive adhesive layer X was formed.

Subsequently, the pressure-sensitive adhesive layer X formed on the separator film was transferred onto the polarizing film P1 to form a pressure-sensitive-adhesive-layer (cell side)-attached polarizing film P1.

### Examples 1 to 15 and Comparative Examples 1 to 5

Sample 1 was obtained by removing a cover glass C and a viewer-side polarizing film P2 from a liquid crystal panel (iPod touch manufactured by Apple Inc. (a liquid crystal display device with a built-in in-cell touch sensor)) (the polarizing film P2 was removed together with the pressure-sensitive adhesive layer on the liquid crystal cell side). The pressure-sensitive-adhesive-layer (cell side)-attached polarizing film P1 prepared as described above was bonded to the surface of sample 1 exposed by the removal. After separated from the polarizing film P2, the cover film C was cleaned and used. The transparent resin layer (pressure-sensitive adhesive layer) prepared in each of Examples 1 to 15 and Comparative Examples 1 to 5 was transferred onto the cleaned cover film C. Subsequently, the transparent resin layer (pressure-sensitive adhesive layer) on the cover film C was bonded to the polarizing film P1 provided on sample 1, so that evaluation sample 2 was obtained.

### Examples 16 and 17

The transparent resin layer (pressure-sensitive adhesive layer) prepared in Example 2 or 5 was bonded to the other side (viewer side) of the prepared pressure-sensitive-adhesive-layer (cell side)-attached polarizing film P1, which was opposite to the pressure-sensitive adhesive layer side (cell side), so that a polarizing film P1 with pressure-sensitive adhesive layers on both sides (both-sided pressure-sensitive adhesive polarizing film P1) was obtained. The pressure-sensitive adhesive layer (cell side) of the both-sided pressure-sensitive adhesive polarizing film P1 was bonded to the surface of sample 1 exposed by the removal. After separated from the polarizing film PI, the cover film C was cleaned and used. The cleaned cover film C was bonded to the pressure-sensitive adhesive layer (viewer side) of the polarizing film P1 provided on sample 1, so that evaluation sample 2 was obtained.

### Comparative Example 6

The pressure-sensitive-adhesive-layer (viewer side)-attached polarizing film P1 prepared in Example 5 was bonded to the surface of sample 1 exposed by the removal. After separated from the polarizing film P1, the cover film C was cleaned and used. The pressure-sensitive adhesive layer X prepared as described above was transferred onto the cleaned cover film C. Subsequently, the pressure-sensitive adhesive layer X on the cover film C was bonded to the polarizing film P1 provided on sample 1, so that evaluation sample 2 was obtained.

A piece with a size of 100 mm×100 mm was cut from each of the pressure-sensitive-adhesive-layer-attached polarizing films and other samples, and used.

Evaluation sample 2 (liquid crystal panel) was placed on a backlight with a brightness of 10,000 cd, and the orientation of the liquid crystal was disturbed with 5 kV static electricity generated by an electrostatic generator ESD (ESD-8012A manufactured by Sanki Electronic Industries Co., Ltd.). The time (seconds) required for recovery from the orientation failure-induced display failure was measured with an instantaneous multichannel photodetector system (MCPD-3000 manufactured by Otsuka Electronics Co., Ltd) and evaluated according to the criteria below.

⊙: Display failure disappeared in a time of less than one second.

◯: Display failure disappeared in a time of one second to less than 10 seconds.

x: Display failure disappeared in a time of 10 seconds or more.

TABLE 1

| | | | | | | Evaluations | | | | | | | |
|---|---|---|---|---|---|---|---|---|---|---|---|---|---|
| Com- | | | | | | | | | | | | | |
| ponent | Ionic compound (wt parts) | | | | | | | | | | ESD gun test | | |
| Poly- | | | Organic | | | | | | | | | Material | |
| functional | | | cation-anion | | Physical | | | | | | Side where | on which | |
| monomer | Alkali metal | | salt | | properties | Surface | | | | | transparent | transparent | |
| (wt parts) | salt | | Liquid | Solid | Thickness | resistance | Durability | | | Haze | resin layer is | resin | Uneven- |
| TMPTA | LiTFSA | KTFSA | Salt | Salt | (μm) | Ω/□ | 80° C. | 100° C. | 60/90 | % | placed | layer is formed | ness |
| 0.01 | 1 | | | | 20 | 1.4E+11 | ◯ | ◯ | ◯ | 0.1 | Viewer side | Cover glass | ◯ |
| 0.01 | 1 | | | | 50 | 1.3E+11 | ◯ | ◯ | ⊚ | 0.1 | Viewer side | Cover glass | ◯ |
| 0.01 | 1 | | | | 100 | 1.2E+11 | ⊚ | ◯ | ⊚ | 0.1 | Viewer side | Cover glass | ◯ |
| 0.01 | 1 | | | | 150 | 1.1E+11 | ⊚ | ◯ | ⊚ | 0.2 | Viewer side | Cover glass | ⊚ |
| 0.01 | 1 | | | | 200 | 9.0E+10 | ⊚ | ◯ | ⊚ | 0.3 | Viewer side | Cover glass | ⊚ |
| 0.01 | 1 | | | | 300 | 8.7E+10 | ⊚ | ◯ | ⊚ | 0.5 | Viewer side | Cover glass | ⊚ |
| 0.01 | 0.1 | | | | 150 | 2.0E+12 | ⊚ | ◯ | ⊚ | 0.1 | Viewer side | Cover glass | ◯ |
| 0.01 | 0.5 | | | | 150 | 9.2E+12 | ⊚ | ◯ | ⊚ | 0.2 | Viewer side | Cover glass | ◯ |
| 0.01 | 2 | | | | 150 | 7.7E+10 | ◯ | ◯ | ⊚ | 0.3 | Viewer side | Cover glass | ⊚ |
| 0.01 | 5 | | | | 150 | 8.4E+09 | ◯ | ◯ | ◯ | 0.5 | Viewer side | Cover glass | ⊚ |
| 0.01 | | 1 | | | 150 | 4.2E+11 | ⊚ | ◯ | ⊚ | 0.1 | Viewer side | Cover glass | ◯ |
| 0.01 | | | 1 | | 150 | 2.0E+11 | ⊚ | ◯ | ⊚ | 0.1 | Viewer side | Cover glass | ◯ |
| 0.01 | | | | 1 | 150 | 2.2E+11 | ⊚ | ◯ | ⊚ | 0.1 | Viewer side | Cover glass | ◯ |
| 0.01 | 1 | | | | 150 | 8.2E+10 | ⊚ | ◯ | ⊚ | 0.1 | Viewer side | Cover glass | ⊚ |
| 0.01 | 1 | | | | 150 | 8.7E+11 | ◯ | ◯ | ◯ | 0.1 | Viewer side | Cover glass | ◯ |
| 0.01 | 1 | | | | 50 | 1.3E+11 | ◯ | ⊚ | ⊚ | 0.1 | Viewer side | Polarizing film | ◯ |
| 0.01 | 1 | | | | 200 | 9.0E+10 | ⊚ | ⊚ | ⊚ | 0.3 | Viewer side | Polarizing film | ⊚ |
| 0.01 | 0 | | | | 20 | >10¹² | ◯ | ◯ | ◯ | 0.1 | Viewer side | Cover glass | X |
| 0.01 | 0 | | | | 100 | >10¹² | ⊚ | ◯ | ⊚ | 0.2 | Viewer side | Cover glass | X |
| 0.01 | 0 | | | | 300 | >10¹⁵ | ⊚ | ◯ | ⊚ | 0.2 | Viewer side | Cover glass | X |
| 0.01 | 0 | | | | 100 | >10¹² | ⊚ | ◯ | ⊚ | 0.2 | Viewer side | Cover glass | X |
| 0.01 | 0 | | | | 100 | >10¹² | ⊚ | ◯ | ⊚ | 0.2 | Viewer side | Cover glass | X |
| 0.01 | 1 | | | | 200 | 9.0E+10 | ⊚ | ◯ | ⊚ | 0.3 | Liquid crystal | Polarizing film | X |
| | | | | | | | | | | | cell side | | |

In Table 1, 2EHA represents 2-ethylhexyl acrylate, NVP N-vinylpyrrolidone, 4HBA 4-hydroxybutyl acrylate, MEA methoxyethyl acrylate, TMPTA trimethylolpropane triacrylate, LiTFSA lithium bistrifluoromethanesulfonylamide, KTFSA potassium bistrifluoromethanesulfonylamide, Liquid Salt methylpropylpyrrolidinium bistrifluoromethanesulfonylamide salt (melting point 12° C.), and Solid Salt ethylmethylpyrrolidinium bistrifluoromethanesulfonylamide salt (melting point 90° C.).

### DESCRIPTION OF REFERENCE SIGNS

A transparent resin layer
B image display device
C component (a touch panel or a transparent substrate)
1 polarizing film
2 pressure-sensitive adhesive layer
3 transparent conductive layer (antistatic layer)
4 glass substrate
5 liquid crystal layer
6 driving electrode
7 antistatic layer functioning also as a sensor layer
8 driving electrode functioning also as a sensor layer
9 sensor layer
11 transparent substrate
12 transparent conductive film

1. A transparent resin layer to be placed more on a viewer side than a most viewer side polarizing film among at least one polarizing film used in an image display device,
the transparent resin layer having a surface resistance of 1.0×10¹³Ω/□ or less.

2. The transparent resin layer according to claim 1, which has a thickness of 5 μm to 1 mm.

3. The transparent resin layer according to claim 1, which has a value of 1.0×10¹² Ω·cm or less calculated by multiplying the surface resistance (Ω/□) by a thickness (cm) of the transparent resin layer.

4. The transparent resin layer according to claim 1, wherein a formation material of the transparent resin layer comprises an acryl-based polymer as a base polymer.

5. The transparent resin layer according to claim 1, wherein a formation material of the transparent resin layer comprises an ionic compound.

6. The transparent resin layer according to claim 1, wherein a formation material of the transparent resin layer is a transparent pressure-sensitive adhesive.

7. The transparent resin layer according to claim 1, wherein a formation material of the transparent resin layer is made from a transparent liquid resin.

8. The transparent resin layer according to claim 1, which is for use on a touch panel.

9. The transparent resin layer according to claim 1, which is for use in a liquid crystal display device having a built-in in-cell or on-cell touch sensor.

10. A pressure-sensitive-adhesive-layer-attached polarizing film, comprising:
a most viewer side polarizing film among at east one polarizing film used in an image display device; and
a pressure-sensitive adhesive layer to be placed more on a viewer side than the most viewer side polarizing film, wherein
the pressure-sensitive adhesive layer is the transparent resin layer according to claim 6 made from a transparent pressure-sensitive adhesive.

11. An image display device, comprising:
at least one polarizing film; and
at least one transparent resin layer according to claim 1 provided more on a viewer side than a most viewer side polarizing film among at least one polarizing film used in the image display device.

12. An image display device, comprising:
at least one polarizing film; and
at least one transparent resin layer provided more on a viewer side than a most viewer side polarizing film among at least one polarizing film used in the image display device,
wherein the transparent resin layer having a surface resistance of 1.0×10¹³Ω/□ or less,
wherein the transparent resin layer is provided as the pressure-sensitive adhesive layer of the pressure-sensitive-adhesive-layer-attached polarizing film according to claim 10.

13. The transparent resin layer according to claim 2, which has a value of 1.0×10¹² Ω·cm or less calculated by multiplying the surface resistance (Ω/□) by a thickness (cm) of the transparent resin layer.

14. The transparent resin layer according to claim 2, wherein a formation material of the transparent resin layer comprises an acryl-based polymer as a base polymer.

15. The transparent resin layer according to claim 3, wherein a formation material of the transparent resin layer comprises an acryl-based polymer as a base polymer.

16. The transparent resin layer according to claim 2, wherein a formation material of the transparent resin layer comprises an ionic compound.

17. The transparent resin layer according to claim 3, wherein a formation material of the transparent resin layer comprises an ionic compound.

18. The transparent resin layer according to claim 4, wherein a formation material of the transparent resin layer comprises an ionic compound.

19. The transparent resin layer according to claim 2, wherein a formation material of the transparent resin layer is a transparent pressure-sensitive adhesive.

20. The transparent resin layer according to claim 3, wherein a formation material of the transparent resin layer is a transparent pressure-sensitive adhesive.
